(19) United States
(12) Patent Application Publication
(10) Pub. No.: US 2023/0182106 A1
(43) Pub. Date: Jun. 15, 2023

(54) SYSTEMS AND METHODS FOR SELECTIVE REDOX REACTIONS

(71) Applicant: Soane Labs, LLC, Riviera Beach, FL (US)

(72) Inventor: David S. Soane, Coral Gables, FL (US)

(21) Appl. No.: 18/079,952

(22) Filed: Dec. 13, 2022

Related U.S. Application Data
(60) Provisional application No. 63/288,876, filed on Dec. 13, 2021.

(51) Int. Cl. B01J 19/12; B01J 19/08

(52) U.S. Cl. CPC B01J 19/126; B01J 19/088; B01J 2219/0884; B01J 2219/0894; B01J 2219/1227

(57) ABSTRACT

The invention includes systems for producing a selective oxidation product that include an oxidant gas source providing an oxidizing agent; a delivery system for the oxidizing agent in fluid communication with the oxidant gas source, wherein the delivery system delivers the oxidizing agent into a plasma reactor, and wherein the plasma reactor energizes the oxidizing agent as a plasma to produce activated oxidant species; a secondary reactant source providing a secondary reactant in a secondary reactant stream that is separated from the oxidant gas, wherein the secondary reactant stream is directed to contact the activated oxidant species in a reaction zone, and wherein the contact between the activated oxidant species and the secondary reactant in the reaction zone produces a reaction that yields the selective oxidation product.

### RELATED APPLICATION

This application claims the benefit of U.S. Provisional Application No. 63/288,876, filed Dec. 13, 2021. The entire teachings of the above application are incorporated herein by reference.

### FIELD OF THE APPLICATION

This application relates to systems and methods using plasma technology for selective oxidation and reduction of hydrocarbon-containing feedstocks and other secondary reactants to form higher-value chemical products.

### BACKGROUND

Petrochemical processing, which converts crude oil and natural gas into other useful chemical products, accounts for about 14% of the total use of crude oil and about 8% of the total use of natural gas. These fossil fuel feedstocks, representing about 87% of the feedstocks used in the carbon-based chemical industry, are used to form more basic chemical building blocks that act as starting materials for industrial downstream processes.

A major carbon-containing building block for the chemical industry is methanol, which is used to form a wide range of industrial products, including high-energy fuels, synthetic fabrics and fibers used in textiles, paints, adhesives, construction materials, pharmaceuticals, and agrochemicals. In certain applications, methanol is used to synthesize chemicals including acetic acid, formaldehyde, methyl methacrylate, methyl tert-butyl ether, and the like.

Methane is the main feedstock for producing methanol, primarily from the steam reforming of methane (SMR). SMR reacts methane with steam at temperatures of about 700-1000° C. under about 3-25 atmospheres of pressure, yielding syngas, i.e., carbon monoxide and hydrogen, as shown in the following equation, EQ1:

CH₄+H₂O(+heat)→CO+3H₂ (ΔH=206 kJ/mol) EQ1:

CO resulting from SMR can be catalytically converted to form methanol, or the CO can be used in a Fischer-Tropsch process to form higher hydrocarbons. Syngas made by reforming methane is used to make over 45 billion kg of methanol per year.

As indicated by the reactions above, the conditions for converting methane into more useful chemical products are energy-intensive, requiring high temperatures and pressures and elaborate, specialized equipment for carrying out the necessary reactions. Thus, the industrial conversion of methane to methanol is costly, with the production of syngas being the most expensive step. Moreover, the large amount of energy required for this process typically is generated conventionally, from fossil fuel combustion that emits CO₂ and thus places a burden on the environment.

Apart from being combusted to form CO₂ and energy, methane is a difficult molecule to use in other chemical reactions because it is relatively inert, with high C—H bond strength (439 kJ/mol), high ionization energy, low polarizability, weak acidity, and low electron and proton affinity. While the C—H bond in methane can be kinetically and thermodynamically activated to undergo oxidation, oxidizing methane typically takes place completely, producing CO₂ as the carbon-containing reaction product; lower carbon oxidation states are not produced. If partial oxidation of methane were undertaken in order to produce methanol, any resulting methanol reaction products instead would be completely oxidized to CO₂, because the C—H bond (˜47 kJ/mol) in methanol is weaker than that of methane. Any methanol intermediate products of CH₄ oxidation are completely oxidized to CO₂ under those reaction conditions at work for methane activation.

Thus, using methane to produce methanol faces two separate problems: activating the C—H bonds in methane adequately to permit reactions to occur in the first place, and selecting for less oxidized reaction products such as methanol to be formed from methane instead of fully oxidized CO₂. Similar challenges face the production of oxidized reaction products from other alkanes. The C—H bonds in higher alkanes, like those in methane, are highly stable. Moreover, as with methane, the desired oxidation products in lower oxidation states are typically more reactive than the starting alkanes so that they are further oxidized before recovery, which can yield the undesirable, fully oxidized reaction product CO₂. Direct, single-step alkane partial oxidation therefore is not an economical process that is practiced commercially; instead, partial oxidation reactions for alkanes are multistep processes that require expensive separation stages and that generate CO₂ requiring removal/recycling. With the abundance of methane as an inexpensive resource, and with the need for methanol as a precursor for other, higher-value chemicals, it would be desirable to utilize methane more efficiently to produce methanol under less costly and environmentally stressful conditions. It would further be desirable to develop economical processes for partially oxidizing other alkane molecules to produce useful chemicals, for example, by functionalizing one or more of the C—H bonds. Because of harsh reaction conditions needed to activate the C—H bonds and the reactivity of the partial oxidation products under the same conditions, selective (partial) oxidative conversion of alkanes has remained an elusive goal.

Plasma-based systems have been investigated as methods for activating oxygen or other oxidants in combination with a secondary organic reactant that is oxidized in the reaction (e.g., a hydrocarbon or other organic co-reactant (whether an alkane, alkene, alkyne, or an aromatic molecule, any of which can optionally contain oxygen or other heteroatoms)), in order to combine the reactive species derived from both gases to form useful carbon-containing products. Conventional plasma-based oxidation systems subject a mixture of the oxidant and the secondary reactant to the high energy conditions of the plasma state in order to produce the desired products. Conventional oxidation of a hydrogen-containing feedstock to form more valuable but less stable products is a demanding process however, with low yield and poor efficiency. Non-thermal plasma (NTP) has been employed to improve the yield and efficiency of such processes, providing a lower energy milieu and less harsh reaction conditions. NTP is known to enable thermodynamically adverse chemical reactions to occur at ambient or near-ambient conditions. NTP for oxidation as currently employed combines a primary reactant (the oxidizing agent) with a secondary reactant that is oxidized to form a plasma. However, energizing this mixture in the NTP still produces a complex mix of reaction products with low yield of the desired chemical; even with the use of NTP, these oxidation processes are insufficiently selective.

Similarly, it would be desirable to develop economical processes for partially reducing hydrocarbon molecules in order to produce useful chemicals. Using a reductant such as hydrogen gas can effect the hydrogenation of a secondary reactant by reducing one or more unsaturated bonds, and more complex reduction reactions can be performed using a longer-chain hydrocarbon (with or without other functional groups or heteroatoms), which can be reduced. However, as with oxidation, selective (partial) reduction conversion of alkanes has remained an elusive goal. Conventional reaction systems tend to reduce the hydrocarbon molecules more or less completely, defeating the effort to convert an unsaturated hydrocarbon to a less saturated hydrocarbon without reducing it completely. Desirably, a reduction could be carried out selectively, for example converting an aldehyde or ketone to an alcohol, or forming hydrogenated single C—C bonds in the place of the C═C double or triple bonds in the secondary reactant, or converting a triple bond to a double bond.

NTP has been investigated as a method for activating hydrogen or other reducing agents to effect the reduction of a secondary organic reactant in order to convert the secondary reactant into more useful carbon-containing products. For example, a C═C double bond in an organic molecule can be reduced to a C—C single bond, or a C═O bond in an organic molecule can be reduced to a C—OH bond. As currently employed, reduction processes involving NTP combine a primary reactant acting as a reducing agent with a secondary reactant that is reduced in a mixture to form a plasma. Using NTP, a more oxidized secondary reactant, such as unsaturated hydrocarbons, carboxylic acids, oxidized oils, and the like, can be reduced by a primary reactant (the reducing agent) so that the secondary reactant is returned to a less oxidized state that may be more suitable for other uses. For example, acetylene can be reduced to ethylene, or carboxylic acids can be reduced to alcohols or aldehydes/ketones. Even with the use of NTP though, these reduction processes are plagued with low yields and complex mixtures of products, and furthermore require expensive and easily poisoned catalysts to isolate the desired product.

There remains a need in the art, therefore, for systems and methods to produce partially (selectively) oxidized and partially (selectively) reduced hydrocarbon products more efficiently and under less strenuous reaction conditions (lower temperatures, lower pressures, and resulting lower energy requirements), with less need for separating reaction products and with less production (respectively) of the fully oxidized CO₂. or fully reduced saturated hydrocarbons.

### BRIEF DESCRIPTION OF FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing features of a conventional, prior art dielectric barrier discharge system.

FIG. 2 is a block diagram showing features of a selective oxidation system as disclosed herein.

FIGS. 3A and 3B are schematic diagrams (cross-sectional and longitudinal projections) of an embodiment of a selective oxidation system.

FIG. 4 is a schematic cross-sectional diagram of an embodiment of a selective oxidation system.

FIG. 5 is a schematic diagram of an embodiment of a selective oxidation system in which a flow of an oxidant is directed into a plurality of high-energy regions.

FIG. 6 is a schematic diagram of an embodiment of a selective oxidation system.

### SUMMARY OF THE INVENTION

Disclosed herein, in embodiments, are systems for producing a selective oxidation product, comprising an oxidant gas source providing an oxidizing agent; a delivery system for the oxidizing agent in fluid communication with the oxidant gas source, wherein the delivery system delivers the oxidizing agent into a plasma reactor, and wherein the plasma reactor energizes the oxidizing agent as a plasma to produce activated oxidant species; a secondary reactant source providing a secondary reactant; a conduit in fluid communication with the secondary reactant source, wherein the conduit directs the secondary reactant to contact the activated oxidant species, wherein contact between the activated oxidant species and the secondary reactant produces the selective oxidation product, and wherein the selective oxidation product is entrained in an effluent fluid stream. In embodiments, the plasma reactor comprises a dielectric barrier discharge system. In embodiments, the plasma reactor is formed as a cylinder having an inlet at its proximal end in fluid communication with the delivery system and an outlet at its distal end in fluid communication with the conduit, and wherein the oxidizing agent enters the inlet, is converted to the plasma within the plasma reactor, and exits through the outlet as activated oxidant species, and the conduit can be an external cylinder that surrounds the plasma reactor. In embodiments, the secondary reactant comprises molecular hydrogen or is a hydrogen source molecule, which can be a liquid, and/or which can be an aliphatic compound; if a liquid, it can be sprayed as an aerosol to contact the activated oxidant species. In embodiments, the secondary reactant is selected from the group consisting of alkanes, alkenes, alkynes, and aromatic compounds. In embodiments, the secondary reactant comprises oxygen or sulfur. In embodiments, the conduit is a planar structure. In embodiments, the activated oxidant species passes through pores in the plasma reactor to contact the secondary reactant. In embodiments, the chemical reaction product is selected from the group consisting of alcohols, aldehydes, ethers, esters, ketones, epoxides, and organic acids. In embodiments, the effluent stream is a gaseous stream, and the effluent stream can comprise a gas phase and a liquid phase. In embodiments, the system further comprises a separator in fluid communication with the effluent stream that separates the chemical reaction product from the effluent stream, and the separator can perform a technique selected from the group consisting of liquefaction, condensation, adsorption, and membrane separation.

Further disclosed, in embodiments, are methods of reacting oxygen and a secondary reactant to form a reaction product, comprising providing an oxygen source, providing a secondary reactant source, and providing a plasma reactor; directing oxygen from the oxygen source to enter the plasma reactor; energizing the oxygen within the plasma reactor to form activated oxygen species; and directing a secondary reactant from the secondary reactant source to interact with the activated oxygen species, thereby forming the reaction product within a product stream. In embodiments, these methods can further comprise separating the reaction product from the product stream.

Also disclosed herein, in embodiments, are systems for producing a selective reduction product, comprising a reductant gas source providing a reducing agent; a delivery system for the reducing agent in fluid communication with the reductant gas source, wherein the delivery system delivers the reducing agent into a plasma reactor, and wherein the plasma reactor energizes the reducing agent as a plasma to produce activated reductant species; a secondary reactant source providing a secondary reactant; a conduit in fluid communication with the secondary reactant source, wherein the conduit directs the secondary reactant to contact the activated reductant species, wherein contact between the activated reductant species and the secondary reactant produces the selective reduction product, and wherein the selective reduction product is entrained in an effluent fluid stream.

In addition, in embodiments, methods are disclosed herein for reacting a reductant and a secondary reactant to form a reaction product, comprising providing a reducing agent source for the reductant, providing a secondary reactant source, and providing a plasma reactor; directing the reductant from the reducing agent source to enter the plasma reactor; energizing the reductant within the plasma reactor to form activated reductant species; and directing a secondary reactant from the secondary reactant source to interact with the activated reductant species, thereby forming the reaction product within a product stream.

Further disclosed herein, in embodiments, are systems for producing a selective oxidation product, comprising a oxidant gas source providing an oxidizing agent; a delivery system for the oxidizing agent in fluid communication with the oxidant gas source, wherein the delivery system delivers the oxidizing agent into a plasma reactor, and wherein the plasma reactor energizes the oxidizing agent as a plasma to produce activated oxidant species; and a secondary reactant source providing a secondary reactant in a secondary reactant stream that is separated from the oxidizing agent, wherein the secondary reactant stream is directed to contact the activated oxidant species in a reaction zone, and wherein contact between the activated oxidant species and the secondary reactant in the reaction zone produces a reaction that yields the selective oxidation product. In embodiments, the oxidizing agent is selected from the group consisting of water vapor, hydrogen peroxide, carbon monoxide, lower chain hydrocarbon oxygenates, alcohols, aldehydes, and ketones. In embodiments, the oxidizing agent comprises a heteroatom, which can be a halogen atom. In embodiments, the plasma reactor forms a non-thermal plasma; the plasma reactor can comprise a dielectric barrier discharge system or a microwave discharge system.

In embodiments, the plasma reactor is formed as a cylinder having a proximal end and a distal end, and having an inlet at the proximal end in fluid communication with the delivery system and an outlet at the distal end in fluid communication with the reaction zone, and wherein the oxidizing agent enters the inlet, is converted to the activated oxidant species within the plasma reactor, and exits through the outlet as activated oxidant species to enter the reaction zone. In embodiments, the activated oxidant species can pass through pores in the plasma reactor to enter the reaction zone to contact the secondary reactant therein. In embodiments, the secondary reactant is a hydrogen source compound. In embodiments, the hydrogen source compound is an aliphatic compound. In embodiments, the secondary reactant is selected from the group consisting of alkanes, alkenes, alkynes, and aromatic compounds. In embodiments, the secondary reactant comprises a heteroatom. In embodiments, the selective oxidation product is selected from the group consisting of alcohols, aldehydes, ethers, esters ketones, epoxides, and organic acids. In embodiments, the hydrogen source compound is a liquid, which can be is dispensed as an aerosol to contact the activated oxidant species in the reaction zone.

In certain systems, the secondary reactant is energized separately and delivered to the reaction area in an activated state. In embodiments, the secondary reactant stream is directed through a conduit to contact the activated oxidant species in the reaction zone. The conduit can be an external cylinder that surrounds the plasma reactor, or it can be a planar structure. In embodiments, the selective oxidation product exits the reaction zone in an effluent fluid stream, which can be a gaseous stream or which can comprise a gas phase and a liquid phase. The system can further comprise a separator in fluid communication with the effluent stream that separates the selective oxidation product from the effluent fluid stream, and the separator can perform a technique selected from the group consisting of liquefaction, cryogenic condensation, adsorption, and membrane separation to separate the selective oxidation product from the effluent fluid stream.

Also disclosed herein are systems for producing a selective reduction product, comprising a reductant gas source providing a reducing agent; a delivery system for the reducing agent in fluid communication with the reductant gas source, wherein the delivery system delivers the reducing agent into a plasma reactor and wherein the plasma reactor energizes the reducing agent as a plasma to produce activated reductant species; a secondary reactant source providing a secondary reactant in a secondary reactant stream that is separated from the reductant gas, wherein the secondary reactant stream is directed to contact the activated reductant species in a reaction zone, and wherein the contact between the activated reductant species and the secondary reactant in the reaction zone produces a reaction that yields the selective reduction product. In embodiments, the reducing agent is hydrogen gas.

Further disclosed herein, in embodiments, are methods of reacting an oxidant and a differentially activated secondary reactant to form a selective oxidation product, comprising: providing an oxidant source that produces an oxidant stream comprising the oxidant and providing a secondary reactant source that produces a secondary reactant stream comprising a differentially activated secondary reactant, wherein the oxidant stream and the secondary reactant stream are separated from each other; providing at least one plasma reactor; directing the oxidant stream to enter the at least one plasma reactor while remaining separated from the secondary reactant stream; energizing the oxidant within the at least one plasma reactor to form activated oxidant species, wherein the oxidizing agent and the activated oxidant species remain separated from the secondary reactant stream; entraining the activated oxidant species in an activated oxidant stream; directing the activated oxidant stream comprising the activated oxidant species to exit the at least one plasma reactor to enter a reaction zone; and directing the secondary reactant stream to enter the reaction zone to interact with the activated oxidant species in the reaction zone, wherein the activated oxidant species reacts with the differentially activated secondary reactant in the reaction zone, thereby forming the selective oxidation product. In embodiments, the oxidant in the oxidant stream is a gas. In embodiments, the differentially activated secondary reactant is not activated. In embodiments, the differentially activated secondary reactant is activated in a second plasma reactor prior to the step of directing the secondary reactant stream to interact with the activated oxidant species in the reaction zone. In embodiments, the method further comprises a step of removing the selective oxidation product from the reaction zone in an effluent fluid stream. The effluent fluid stream can be a gaseous stream, or the effluent fluid stream can comprise a gas phase and a liquid phase. In embodiments, the method can further comprise a step of separating the selective oxidation product from the effluent stream, and the step can employ a separation technique selected from the group consisting of liquefaction, cryogenic condensation, adsorption, and membrane separation. In embodiments, the method further comprises a step of directing the effluent fluid stream away from the reaction zone before the step of separating the selective oxidation product from the effluent fluid stream.

Also disclosed herein, in embodiments, are methods for producing a selective oxidation reaction, comprising: providing a primary reactant stream comprising an oxidant; providing a secondary reactant stream comprising a secondary reactant intended to react with the oxidant in the primary reactant stream; separating the primary and the secondary reactant streams and maintaining separation between them; activating the oxidant in a first plasma to form activated an activated oxidant; shielding the secondary reactant from the first plasma to form an activated oxidant; shielding the secondary reactant to maintain the secondary reactant in an differentially activated state; and recombining the activated oxidant with the secondary reactant in the differentially activated state, thereby producing the selective oxidation reaction. In embodiments, the secondary reactant is a hydrogen source reactant. In embodiments, the differentially activated state is an unactivated state.

Further disclosed herein, in embodiments, are methods for producing a selective reduction reaction, comprising providing a primary reactant stream comprising a reductant; providing a secondary reactant stream comprising a secondary reactant intended to react with the reductant in the primary reactant stream; separating the primary and the secondary reactant streams and maintaining separation between them; activating the reductant in the primary reactant stream in a first plasma to form an activated reductant; shielding the secondary reactant from the first plasma to maintain the secondary reactant in a differentially activated state; and recombining the activated reductant with the secondary reactant in the differentially activated state, thereby producing the selective reduction reaction. In embodiments, the differentially activated state is an unactivated state.

### DETAILED DESCRIPTION

### 1. Split-Stream Plasma-Based Systems and Methods for Selective Redox Reactions

To address the problems with conventional oxidation and conventional plasma-based oxidation as described above, it has been unexpectedly discovered that separating oxygen or an oxidant (the primary reactant) from any co-reactants and treating the oxygen or oxidant in its own plasma-based reaction system (apart from secondary reactants) can result in the successful selective oxidation of hydrocarbons and other carbon-containing reactants into higher-value oxygenates with good yield, selectivity, and energy efficiency. Similarly, to address the problems with conventional reduction and conventional plasma-based reduction described above, separating the reductant from any secondary reactants and treating the reductant in its own plasma-based reaction system (apart from secondary reactants) can result in the successful selective reduction of organic molecules containing a completely or partially oxidized carbon atom or nitrogen atom, with the formation of more valuable reduced products. Non-thermal plasmas can be harnessed advantageously for these purposes. As used herein, the term “primary reactant” refers to the reactant being activated in the plasma-based system to interact with and effect an intended reaction with a separate compound that is used as a substrate for the reaction with the primary reactant. As used herein, the term “secondary reactant” refers to those secondary species that are presented for reaction with the reactant that has been activated by the plasma (the primary reactant), wherein the reaction of the primary reactant with the secondary reactant results in selective oxidation or reduction (as applicable) of the secondary reactant molecule to produce the desired products. As used herein, the term “activated” includes, without limitation, those vibrationally excited, electronically excited, and dissociated species originating from the reactant due to energy transfer from the plasma; it is recognized that activation can also be performed using other energy sources besides those involved in the formation of plasma, such as thermal energy or other conventional sources. The present invention focuses on activation as takes place in a plasma, preferably a NTP, although such activation can be combined with other types of activation without departing from the principles of these systems and methods.

At its most basic level, a NTP is generated by placing two electrodes in a gas or gas mixture and creating an electrical potential difference between them. The potential difference can be created by direct current, alternating current, or current pulses. Energy to create a NTP can also be provided by other means, such as microwaves or induction coils. The electrons in the NTP attain a high average energy (1-10 eV) and reach a high average electron temperature (10,000-100,000 K), while the temperature in the gas itself remains low. The high electron energies and temperatures allow the dissociation and/or activation of the gas molecules in the plasma, so that they can rearrange and react to form other products. Plasma can activate primary reactant molecules by ionization, excitation, and dissociation, creating a cascade of reactive species (excited atoms, ions, radicals, and molecules) to propagate and initiate other chemical reactions.

Such a system, with separation of the two reactants and with selective plasma energization of the primary reactant (whether an oxidant or a reductant) separated from the secondary reactant is referred to herein as a “split-stream” plasma-based system. The secondary reactant that is separated from the primary reactant can remain unactivated when it is rejoined with the activated primary reactant, or it can be activated separately in a different plasma system under different reaction conditions. In either case, whether unactivated or activated differently than, but separated from, the primary reactant, the secondary reactant can be designated as “differentially activated,” to capture these two possibilities (i.e., activated not at all, or activated differently than but separately from the primary reactant). In the systems and methods disclosed herein, such split-stream systems with an activated primary reactant and a differentially activated secondary reactant can be used effectively for various selective oxidation and reduction (redox) processes.

Selective oxidation or selective reduction can be performed using the systems and methods disclosed herein to avoid the limitations of conventional plasma-assisted redox reactions. As used herein, the term “selective oxidation” includes any process that causes an oxidizing agent or oxidant as a primary reactant to combine chemically with other carbon-containing molecules (secondary reactants) to form desired, selected-for, and typically more valuable, carbon-containing compounds such as alcohols, aldehydes, ethers, esters, ketones, epoxides, and organic acids having a desired oxidation number (whether greater than or equal to the oxidation number of the secondary reactant), while avoiding the substantial production of byproducts in which the carbon atoms are fully oxidized. Provided that the substantial production of fully oxidized carbon-containing byproducts is avoided, the products of selective oxidation can include carbon-containing compounds with carbon atoms that are more oxidized or less oxidized than the desired carbon-containing compounds. As used herein, in addition to its ordinary meaning the term “substantial” means within acceptable limits or degree, as would be understood by one of ordinary skill in the art; for example, avoiding the substantial production of byproducts as described above means that, while such byproducts may be produced by these systems and methods, their presence is within limits deemed acceptable by skilled artisans, for example, an amount capable of removal using acceptable techniques, or an amount that does not impair the production or recovery of other, more desirable carbon-containing products. Similarly, the term “selective reduction” includes any process that causes a reducing agent or reductant as a primary reactant to combine chemically with other carbon-containing molecules (secondary reactants) to form desired, selected-for, and typically more valuable, reduced compounds having a desired oxidation number (whether less than or equal to the oxidation number of the secondary reactant), while avoiding the substantial production of byproducts in which the carbon atoms are fully reduced. Provided that the substantial production of fully reduced carbon-containing byproducts is avoided, the products of selective reduction can include carbon-containing compounds with carbon atoms that are more reduced or less reduced than the desired carbon-containing compounds. For both selective oxidation and selective reduction, the systems and methods disclosed herein can be modified, or “tuned,” to favor (select for) the production of certain products while disfavoring the production of other products such as less desirable products and undesirable byproducts. Moreover, a product stream containing a mixture of desirable and less desirable products, and/or containing undesirable byproducts can be separated so that the desirable products can be recovered, and/or the less desirable products can be optionally separated or recovered, and/or the undesirable byproducts can be excluded, using methods familiar to those of ordinary skill in the art.

The selective oxidation of methane provides an example of the advantages of the split-stream plasma-based system. Using methane as the differentially activated secondary reactant, a selective oxidation of methane can produce methanol according to the following reaction (EQ2):

CH₄+1/2 O₂→CH₃OH (ΔH⁰_{298K}=−126.2 kJ/mol) EQ2:

In the reaction shown in EQ2, methane is oxidized selectively to methanol, that is, with the production of the desired molecule (methanol) and without production of other undesired byproducts. Such selectivity is not available using conventional technologies, nor is a straightforward reaction from methane to methanol available in a single reaction step. Advantageously, using NTP, the reaction shown in EQ2 can be carried out with the oxygen reactant being derived from the activated oxygen species produced by the NTP, thus offering an alternate pathway for producing methanol instead of the conventional multistep process involving syngas as described above.

Similarly, selective reduction using a split-stream plasma-based system as disclosed herein offers an alternative to conventional processes such as Fischer-Tropsch synthesis, in which hydrogen and carbon monoxide (syngas) are converted into higher molecular weight hydrocarbons under high temperatures and pressures with the use of catalysts. Fischer-Tropsch synthesis reduces the carbon monoxide by reacting it with hydrogen according to the following equations (EQ3 and EQ4) to form higher molecular weight hydrocarbons:

nCO+(2n+1) H₂→CₙH₂ₙ₊₂+nH₂O (for alkanes) EQ3:

nCO+2nH₂→CₙH₂ₙ+nH₂O (for alkenes) EQ4:

The Fischer-Tropsch process is considered to be a catalytic polymerization in which methylene (—CH₂—) subunits are formed that are subsequently combined to form the longer-chain hydrocarbon products. Additional processing of the Fischer-Tropsch reaction products is required to separate them into their components so that the commercially useful products can be isolated, or so that the longer chains can be cracked into small units that can be rearranged to yield isomers that have desired properties for designated uses, for example, as fuels.

Using plasma-based selective reduction in accordance with the systems and methods of the present invention, the Fischer-Tropsch process can be replaced by a more direct reduction of carbon monoxide gas or any other secondary reactant by using activated hydrogen gas as the primary reactant (reductant). Using NTP in accordance with the present invention, such a reaction can be carried out as described in EQ3 and EQ4 above, with the hydrogen reactant being derived from the activated hydrogen species produced by the NTP, thus offering an alternate pathway for producing alkanes and alkenes instead of the Fischer-Tropsch process.

Using plasma-based selective reduction as disclosed herein can energize a reductant such as hydrogen gas to effect the hydrogenation of a secondary differentially activated reactant, for example, the conversion of an aldehyde or ketone to an alcohol, or the formation of hydrogenated single C—C bonds in the place of the C═C double or triple bonds in the secondary reactant, or the conversion of a triple bond to a double bond. In embodiments, more complex reduction reactions can be performed using a longer-chain, cyclic or aromatic hydrocarbon (with or without other heteroatoms) secondary reactants. Using these systems and methods, reactions can be achieved that produce desirable saturated or selectively unsaturated aliphatic or aromatic molecules of all sizes and complexities, with or without substitutions or additional functional groups. As an example, the byproducts of combustion, including incomplete combustion products, can be reacted using these systems and methods with the ultimate restoration of a reduced state, so that the byproducts of combustion can be recycled for reuse as substrates for subsequent oxidation, e.g., for reuse as fuels. Secondary reactants suitable for reduction can include any organic molecule containing a completely or partially oxidized carbon atom, nitrogen atom, or other heteroatom, while the primary reactants can include any organic molecule capable of acting as an electron donor.

As described herein, NTP plasmas can be used to effect either oxidation or reduction of a targeted secondary reactant. It is understood that oxidation and reduction are paired reactions: if the secondary reactant is oxidized, the primary reactant is reduced, and vice versa. The paired reactions carried out by the systems and methods disclosed herein can therefore be termed “selective redox reactions,” as they involve paired oxidation/reduction mechanisms to yield the selective and targeted generation of the desired reaction product either by oxidizing or reducing the secondary reactant and correlatively reducing or oxidizing the primary reactant without the significant formation of unwanted byproducts; those products formed by selective redox reactions are “selective redox products.”

### 2. Exemplary Split-Plasma-Based Selective Redox Reactions

a. Conventional NTP for Hydrocarbon Oxidation

At its most basic level, a NTP is generated by placing two electrodes in a gas or gas mixture and creating an electrical potential difference between them. The potential difference can be created by direct current, alternating current, or current pulses. Energy to create a NTP can also be provided by other means, such as microwaves or induction coils. The electrons in the NTP attain a high average energy (1-10 eV) and reach a high average electron temperature (10,000-100,000 K), while the temperature in the gas itself remains low. The high electron energies and temperatures allow the dissociation and/or activation of the gas molecules in the plasma, so that they can rearrange and react to form other products. Starting from a hydrocarbon and plasma mixture, a plasma can activate reactant hydrocarbon molecules by ionization, excitation, and dissociation, creating a cascade of reactive species (excited atoms, ions, radicals, and molecules) to propagate and initiate other chemical reactions, including combining with oxygen species to form desired oxygenates, as will be described in more detail in this section.

A number of NTP techniques can be applied to initiate and sustain hydrocarbon oxidation, offering different electrode geometries, applied pressures, and plasma generation methods. Mechanisms such as dielectric barrier discharge (DBD), microwave (MW) discharge, and gliding arc (GA) discharge can be used to form the NTP; other types of NTP can include, without limitation radiofrequency (RF) discharge, corona discharge, glow discharge, and nanosecond pulse discharge.

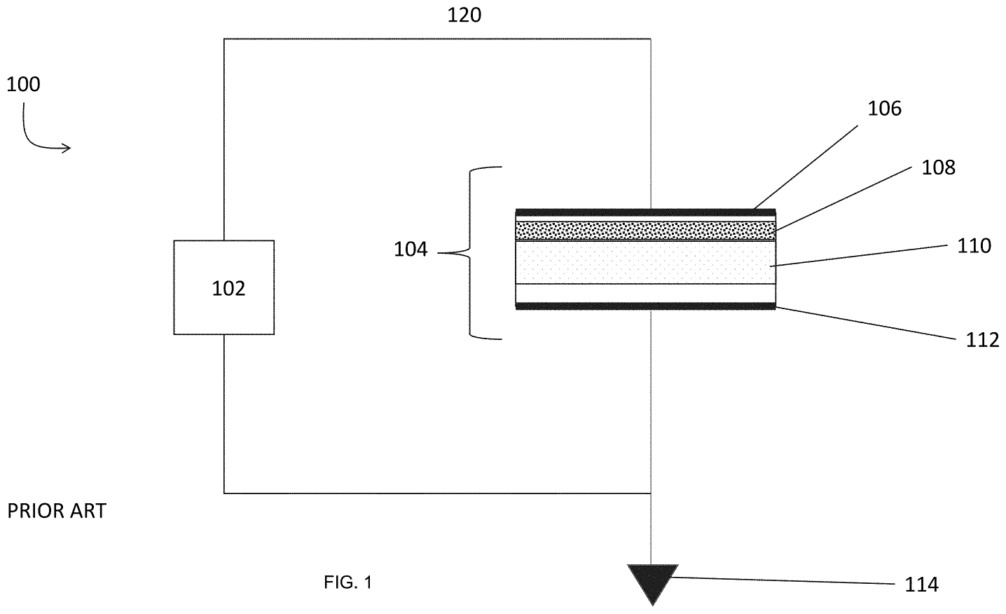

FIG. 1 illustrates schematically the generic components of an exemplary DBD system for plasma generation, as would be familiar to skilled artisans. As shown in FIG. 1, a DBD system 100 includes a power supply 102 and a reactor assembly 104 (shown in cross-section), operatively connected by a circuit 120 and in communication with a ground 114. The power supply provides power to a high voltage electrode 106 (or anode) in the reactor assembly 104, with the ground electrode 112 in the reactor assembly operatively connected to the ground 114. For DBD plasma to be formed, a strong electric field is required. The applied voltage and the distance between the high voltage electrode 106 and the ground electrode 112 determine the strength of the high-energy field that is produced within the reactor region 110; a frequency between 1 KHz and 10 MHz is desirable for generating a DBD plasma. When the electric field is produced, the plasma is generated in the gap between the electrodes. Alternating or direct current can be used in a DBD system.

As shown in this Figure, the high voltage electrode 106 is shielded from the reactor assembly 108 by a dielectric barrier 104, allowing the creation of the high-energy field within the reactor region 110. This high-energy field creates the plasma within the reactor region 110. In embodiments, the reactor region 110 can be formed as a space between the dielectric barrier 108 and the ground electrode 112, for example, if the barrier 108 and the ground electrode 112 are formed as plates, with the high voltage electrode 106 shaped as a plate on top of the dielectric 108. In other embodiments, the reactor region 110 can be formed as a cylinder, with the dielectric barrier 108 surrounding the cylinder, with the high voltage electrode 106 disposed external to the dielectric barrier 108, and with the ground electrode 112 positioned within the cylinder as a coaxial rod. Other arrangements of the components of the reactor assembly 104 will be apparent to artisans of ordinary skill, to permit the generation of the plasma within the reactor region 110 using the DBD system.

Regardless of the mechanism for initiating and sustaining the NTP, this technology has not become commercially adopted to date as a method for oxidation of hydrogen-containing organic reactants and other carbon-containing reactants. As mentioned above, conventional NTP-based processes have been plagued by low energy efficiency and low product yields, because such systems subject a mixture of oxygen (or another oxidant) and one or more carbon-containing secondary reactants such as hydrocarbons to the high energy conditions of the plasma state in order to activate both reactants sufficiently to produce the desired products. It has been recognized, however, that applying NTP to reactant mixtures comprising a hydrogen-containing organic feedstock (such as a hydrocarbon) and oxygen yields a complex mix of reaction products from which the desired product must be separated.

The reason for this complexity is illustrated by the following sets of reactions (EQ5-EQ13 and EQ 14-EQ 19), which show certain behaviors of plasma-activated species of methane and ethane (respectively), which allow them to form a spectrum of reaction products when plasma-activated in mixtures with oxygen. The interaction of the initial hydrocarbon activated species with derivative activated hydrocarbon species and the interaction of the derivative activated species with each other results in a panoply of reactions as set forth below for methane (EQ5-EQ13) and for ethane (EQ 14-EQ 19). Importantly, as shown in the reaction schemes below, the activated hydrocarbon species react with each other as well as with the oxygen, resulting in the complex mix of final products.

The reactions set forth in EQ5-EQ13 are based on energizing a mixture of CH₄ and oxygen together in a non-thermal plasma in order to convert methane to methanol, as might be carried out conventionally. In this system, the plasma generated from the gas mixture produces active species CH₃* and O*, which are intended to combine in the plasma with the ultimate goal of forming CH₃OH. However, these activated species instead combine with each other in myriad ways, so that the NTP-based process yields a mix of reaction products, including ethylene, ethane, formaldehyde, acetaldehyde, CO, CO₂, and water, along with the intended product, CH₃OH. The following reaction paths (EQ5-EQ13) illustrate what can be formed within the plasma when methane and oxygen are the reactive species being energized:

CH₄+e⁻→CH₃*+H*+e⁻ EQ5:

O₂+e⁻→2O+e⁻ EQ6:

2CH₃*→C₂H₆ EQ7:

C₂H₅*+O→CH₃*+CH₂O EQ8:

CH₄+O→CH₃*+*OH EQ9:

CH₃*+O→CH₃O* EQ10:

CH₃*+*OH→CH₃OH EQ11:

CH₃O*+HO₂*→CH₃OH+O₂ EQ12:

CH₃O*+*OH→CH₂O+H₂O EQ13:

In these reaction schemes, it is understood that the primary reaction of oxygen and methane reactants was initiated as a dissociation of an electron from each molecule. However, the combination of the methane radicals to form ethane is the dominant reaction, rather than the oxidation of the methane and/or methane radical species, because the oxidation of methane is slower than the production of ethane; only after ethane is produced does the oxidation of the hydrocarbon take place to yield methanol and formaldehyde. As the complexity of reactions shows, the formation of the desired product, methanol, is disfavored, while the production of other reaction products predominates. The number of the activated species in this fairly simple desired reaction (oxidizing methane to form methanol) results in a surprisingly large number of reaction products, with poor methanol yield and low production efficiency.

When more complex hydrocarbon reactants, for example, longer-chain alkanes, unsaturated hydrocarbons, or heteroatom-containing molecules, are mixed with oxygen to form a non-thermal plasma, a wider range of hydrocarbon-derived activated species is formed. If a light-chain hydrocarbon feedstock like ethane is combined with oxygen in a NTP in order to form desirable oxidation products (e.g., ethanol, acetic acid, or acetaldehyde), a complex mix of reactant products instead results, because the ethane feedstock is energized to produce a number of higher-chain and unsaturated hydrocarbons that may or may not combine further with oxygen to produce oxygenates, and those oxygenates may or may not include useful quantities of the desired C₂ oxygenates. As illustrated from the reaction series shown in simplified form in EQ14-EQ 19, basic reactions derived from plasma-driven ethane activation can cascade to form a number of hydrocarbon species. While these equations do not show the interaction of the hydrocarbon species with activated oxygen that would occur in a mixed O₂ and hydrocarbon plasma, it us understood that the O₂-hydrocarbon mixture in the NTP can yield the insertion of an activated oxygen species at one or more sites along any of the hydrocarbon backbones that have been produced in the plasma, producing carbon oxygenates in any oxidation state. In more detail, NTP reactions pertaining to the hydrocarbon reactant alone can include:

CH₃CH₃→2CH₃* EQ14:

CH₃*+CH₃CH₃→CH₄+CH₃CH₂* EQ15:

CH₃CH₂*→CH₂=CH₂+H* EQ16:

CH₃CH₂*+CH₂=CH₂→CH₃CH₂CH₂CH₂* EQ17:

CH₃*+CH₃CH₂*→CH₃CH₂CH₃ EQ18:

CH₃CH₂*+CH₃CH₂*→CH₂=CH₂+CH₃CH₃ EQ19:

Any of the products resulting from activating the ethane can combine with the activated oxygen also produced in the mixture. While EQ 14-EQ 19 do not illustrate the full spectrum of reaction products formed by a NTP plasma that activates a mixture of O₂ and ethane, it can be appreciated from these sample reactions that a virtually limitless number of reaction products can be formed by energizing a simple molecule like ethane in a non-thermal plasma, since the chain reaction processes can continue as long as there are reactive hydrocarbon species to interact with each other, ultimately yielding longer chain alkanes, alkenes, or aromatics. The introduction of activated oxygen species (not shown in the equations above) then forms oxygenates with the activated hydrocarbon species, resulting in a complex mix of reaction products with varying oxidation states that need to be separated from a desired end product such as ethanol, acetic acid, or acetaldehyde. Therefore, while oxidation of a hydrocarbon feedstock molecule can be effected by combining it with oxygen to form a mixture and energizing the mixture to form a non-thermal plasma, this process yields a relatively small amount of the desired oxygenate, which furthermore needs to be separated out from a complex soup of other, undesired reactants.

The complexity of reactant mix is in large part due to the relative stability of oxygen bonds as compared to the C—H bonds found in alkanes. Diatomic oxygen has a bond dissociation energy of 498 kJ/mol (at 298 K); C—H bonds have lower bond dissociation energies. For example, the bond dissociation energy for the C—H bond in methane is 439 kJ/mol; the bond dissociation energy for the C—H bond in ethane is 423 kJ/mol; the bond dissociation energy for the isopropyl C—H bond is 414 kJ/mol; the bond energy for the t-butyl C—H bond is 404 kJ/mol. These bond dissociation energies explain why a hydrocarbon reactant mixed with oxygen to form a hydrocarbon-oxygen plasma mixture undergoes such a broad spectrum of reactions, and why oxygenate reaction products are formed less advantageously than hydrocarbon reaction products: it is easier to activate the hydrocarbon reactant and its hydrocarbon derivatives, and more difficult to activate the oxygen reactant so that it interacts with the activated hydrocarbon species. If sufficient energy is provided to activate the oxygen, the hydrocarbon reactant and its reaction products can also be activated, and preferentially.

The activation of dioxygen into redox equivalents acting selectively in C—H activation to add oxygen to the carbon backbone is therefore a central challenge for selective oxidation. Part of the challenge arises from the unusual stability of molecular oxygen (dioxygen): molecular oxygen is a ground-state triplet, consisting of two unpaired electrons, one in each of the doubly degenerate π* HOMOs. Thermodynamically, molecular oxygen is a powerful oxidant. However, due to spin conservation, the reaction of molecular oxygen is kinetically unfavorable.

This behavior of molecular oxygen explains why oxidation of hydrocarbons to obtain selected high-value products is so challenging: NTP conditions that are sufficient to activate the oxygen molecule in the plasma mix can preferentially activate the hydrocarbon reactant and can further induce reactions between and among the various activated hydrocarbon species. As a result, plasma-based systems comprising mixtures of activated oxygen and the activated secondary reactant produce low yield of desired oxygenate(s), and poor selectivity for these desired products. Adjusting NTP conditions for these processes to obtain higher amounts of the desired products can result in increased soot production, which can interfere with the performance of the catalysts that the process uses. Moreover, adding more energy to the system, while it can increase the amount of certain oxygenates that are produced, can also decrease the energy efficiency of the process and yield the undesirable mix of hydrocarbon reaction products. Although adding catalysts to the NTP reaction system can improve yield and selectivity, this introduces further complexities due to catalyst chemistry and the interaction of these materials with the plasma itself.

Not to be bound by theory, it is understood that the inert nature of the dimolecular oxygen bonds renders this molecule relatively resistant to plasma energy if other, more reactive molecules are present: in such a mixture, the other, more reactive molecules are preferentially energized, with insufficient energy being available to break the O₂ bonds predictably and efficiently. In such mixtures, it has been observed that activated oxygen species exist in exceedingly low concentrations in the plasma when other gases are also present. In a plasma containing both O₂ and a secondary reactant molecule, the O₂ passes through the plasma reaction zone relatively unactivated, while the plasma energy is absorbed by the secondary reactant to create ionic or radical species derived therefrom. In mixtures with O₂, the more reactive plasma component (such as hydrogen source molecules or other secondary reactant molecules) acts as an “energy thief,” becoming activated in the plasma while the O₂ remains less affected. However, the radicals or ions derived from the secondary reactant have insufficient energy to force the stable O₂ molecules to convert chemically into desired reaction products.

These phenomena explain the unsatisfactory performance of conventional NTP systems that attempt to form higher-value products by energizing mixtures of O₂ and secondary reactants such as organic hydrogen source molecules or other carbon-containing molecules such as CO. As used herein, the term “hydrogen source molecule” refers to a hydrocarbon or another carbon-containing molecule that is subject to oxidation by the oxidative removal of one or more of its hydrogen atoms. The term “hydrogen source molecule” as used herein includes, without limitation, hydrocarbons such as methane, an alkane, an alkene, an alkyne, or an aromatic hydrocarbon, and oxygen-containing hydrocarbons such as an alcohol, a glycol, an ether, a phenol, aldehyde, a ketone, and the like, optionally including other functional groups and/or heteroatoms. Conventional mixtures of O₂ and secondary reactants have been previously used with NTP plasma to perform selective oxidation, but as mentioned previously, these processes have yielded poor results. By contrast, in the systems and methods disclosed herein, hydrogen source molecules can be used as secondary reactants in split-stream plasma-based oxidations, wherein the hydrogen source molecule is oxidized by the energized primary reactant which acts as the oxidant.

b. NTP for Selective Oxidation or Reduction of Secondary Reactants

As described above, it has been unexpectedly discovered that the O₂ molecule or other oxidants can be advantageously activated separately in the plasma, using the NTP as an energy source that would allow the oxidant to combine with a differentially activated secondary reactant to form higher-value oxidized products. In such selective reactions, the desired products can be incompletely oxidized, so that CO₂ formation is minimized or avoided entirely.

In embodiments, oxygen can be used as the primary reactant (the oxidant), yielding as desired reaction products oxygenates that are incompletely oxidized, so that CO₂ formation is minimized or avoided entirely. While O₂ is described herein in detail as an exemplary oxidizing agent in selective oxidation, in embodiments other molecules besides oxygen can be activated in the split stream plasma to act as oxidants to produce selective oxidation according to these systems and methods. An oxidant useful for these purposes can include any molecule whose activation can generate the desired oxidation reaction with a selected secondary reactant; oxidants can be organic or inorganic; in embodiments, an oxidant can produce a dehydrogenation or an oxygen insertion in the carbon background of the secondary reactant. Using this approach, desirable oxygen-containing compounds derived from hydroxyl insertion, addition, or substitution can be selectively produced from organic molecules. Such selective oxidation is made possible by the split-stream plasma reaction systems as disclosed herein.

These selective systems are based on the surprising finding that separating the O₂ or other oxidizing agent from the secondary reactants and activating the oxidizing agent in a plasma as the predominant component of the plasma allows this primary reactant to become sufficiently energized so that it can then interact with the unactivated (non-plasma-treated) secondary reactants or separately activated secondary reactants to produce higher-value chemicals. As used herein, the term “predominant component” of a plasma means that a primary reactant (e.g., the oxidizing agent for selective oxidation reactions and the reducing agent for selective reduction reactions) can be used alone to form the plasma, or it can be combined with other molecules in the plasma as long as the primary reactant is present in sufficient quantities to absorb enough energy in the plasma to become activated. Stated equivalently, at a minimum the primary reactant must be the predominant gas in a mixed feed in a NTP reactor, with the term “predominant” indicating that the primary reactant is present in sufficient quantity that it is energized without “energy theft” from other molecules. As used herein, the term “energy theft” refers to the competitive absorption of energy by a more readily activated reactant in a plasma mixture, with the preferential energization of that reactant in the plasma instead of other co-present reactants; we may term this more readily-activated reactant an “energy thief” as compared to other reactants in the plasma mixture.

If the primary reactant is the predominant component of a mixture, it has more reactivity in the NTP than the other component(s) of the mixture, and/or the primary reactant is present in sufficiently large quantities within the NTP that the activated species of that reactant (either the selective oxidant for selective oxidation, or the selective reductant for selective reduction) are responsible for the intended reactions with the secondary reactant.

Even if the primary reactant is combined with other molecules in the plasma, the plasma's energy is preferentially concentrated on this primary reactant mixture instead of activating other components of the reactant mix; in the split-stream systems and methods disclosed herein, the primary reactant is intentionally activated in the plasma and the secondary reactant is intentionally shielded from activation by the same plasma. As used herein, the term “activated primary reactant” or “activated primary reactant species” includes, without limitation, those vibrationally excited, electronically excited, and dissociated species originating from the primary reactant due to energy transfer from the plasma.

The area in which the activated primary reactant encounters the secondary reactant is termed the “reaction zone,” which is understood to be any area external to the energized portion of the plasma where the primary reactant is being activated. The reaction zone is thus understood to be peripheral to the plasma acting on the primary reactant, with the term “peripheral” encompassing any location that is outside of the energized portion of the plasma where the primary reactant is being activated. The reaction zone can be lateral to, external to, distal to, or otherwise outside of the energized portion of the plasma, allowing the primary reactant to be energized separately before it is combined with the secondary reactant. The reaction between the activated primary reactant species and the secondary reactant takes place rapidly, almost immediately, in the reaction zone before the activated primary reactant species have time to dissipate. In embodiments, the secondary reactant can itself be activated in a separate reactor, with the activated secondary reactant being directed to encounter the activated primary reactant species in a designated reaction zone.

Different types of non-thermal plasma reactors can be used to produce the O₂ or oxidant plasma used by these systems and methods; these systems and methods are sufficiently flexible to be used with any desired type of reactor design. Microwave plasmas or radiofrequency plasmas can be used, though such plasmas can require relatively high pressures for optimum utilization, and can be difficult to harness for continuous (as opposed to batch) processing. As an alternative, a dielectric barrier discharge (DBD) system for plasma generation can offer the advantages of continuous operation under atmospheric pressure, with low operating and maintenance costs.

While the systems and methods of the present invention include those embodiments in which oxygen or another oxidizing agent is the sole energized component of the plasma stream, it is understood that oxygen or any other oxidizing agent can be introduced as part of a gaseous mixture to form the NTP, provided that it is the predominant reactant. For example, air can be employed as a feedgas for a NTP, in which oxygen in the air is the primary reactant that will act as the oxidant for selectively oxidizing the secondary reactant, because it is predominantly activated by the NTP in comparison to the other components of air (e.g., nitrogen and CO₂), which are less reactive.

While oxygen is recognized as a useful and powerful oxidant, selective oxidation using these systems and methods can be performed using other oxidants as the primary reactant, such as water vapor, hydrogen peroxide, carbon monoxide, lower chain hydrocarbon oxygenates such as acetone or ethanol or other alcohols, aldehydes or ketones, or halogens, or sulfur-containing or nitrogen-containing molecules, as will be discussed in more detail below. In addition, sulfur-containing or nitrogen-containing molecules can be used as secondary reactants. For example, a thiol or other organosulfur compound as a secondary reactant can permit the integration of an O₂ or oxidant molecule to form more complex sulfur-containing reaction products. As another example, amines or other secondary reactants containing nitrogen can be combined with activated oxygen species to form more complex nitrogen-containing reaction products such as amino acids.

In embodiments, various techniques can be used to separate and capture the higher-value selective oxidation products produced by the reactions described herein. In an embodiment, the selective oxidation product can be absorbed into a hydrophilic liquid like water, acetone or alcohol, or some other appropriate vehicle for absorption. Since the processes disclosed herein advantageously create familiar commodity product categories such as alcohols, aldehydes, ethers, esters, ketones, epoxides, and organic acids in the low-energy reaction zones, product separation can be conducted using technologies already known in the art of industrial chemistry.

In embodiments, a non-volatile or low-volatility carbon-containing substance in liquid form can be directed to contact the O₂-predominant or other oxidant-predominant plasma or can be injected immediately downstream from the O₂-predominant or other oxidant-predominant plasma to act as a secondary reactant. The liquid can be introduced or injected as a liquid stream, or can be presented to the activated oxygen species distal to the plasma as a pool or a reservoir, or can be atomized into the reaction zone as small droplets, thus increasing the surface area to facilitate contact between the activated oxygen species and the secondary reactant. With more complex carbon-containing substances as secondary reactants, more complex selective oxidation products and mixtures thereof are produced by these processes. Conventional separation techniques can be used to separate the various reaction products and remove the unwanted products from the desirable ones, isolating the various products for commercial uses, for disposal, or for recycling, as applicable. Suitable liquid secondary reactants can be selected to produce specific, desirable products; for example, the liquid secondary reactants can be aromatic or aliphatic in nature, of all chain lengths and complexities, used individually or in mixtures. Hydrogen source molecules advantageously can be biologically produced (e.g., both plant-derived and animal-derived agricultural oils) as well as petroleum-derived.

The systems and methods disclosed herein can proceed without requiring the use of a catalyst, in contrast to the majority of those plasma-based processes used to effect oxidation to produce specific molecular products. It has been recognized, for example, that conventional plasma systems using activated oxygen for oxidation do not provide sufficient energy to form adequate O₂-derived reaction products from O₂ and secondary reactant mixtures, due to the durability of the dimolecular O₂ bond. However, by separating the O₂ from the secondary reactants, e.g., hydrogen-donating reactant(s), and energizing the O₂ selectively using the split-stream plasma systems and methods disclosed herein, the plasma energy is concentrated on the O₂ molecules, yielding activated O₂ capable of reacting more effectively and efficiently with the secondary reactant(s).

It is recognized that catalysts have been typically employed in conventional plasma systems both to increase yields and to facilitate separation. Due to the relative resistance of dimolecular oxygen to plasma activation, for example, catalysts are typically required for conventional plasma-assisted oxidation to produce specific molecular products. Recognizing the drawbacks of using catalysts in plasma-based processes, the present systems and methods can advantageously proceed without catalysts. While reactions without catalysts are preferable under most circumstances, in certain embodiments catalysts can be used to augment, accelerate, or otherwise improve certain parameters of the reactions disclosed herein.

Thus, using the technologies disclosed herein, catalysts can be avoided. However, despite the advantages to a catalyst-free system, the use of a catalyst can be advantageous under certain circumstances, and catalysts can be optionally employed with the systems and methods disclosed herein. In embodiments, plasma-assisted selective oxidation can be carried out using these systems and methods with the inclusion of optional catalysts that are familiar to skilled artisans in the field, in conventional configurations such as powders, wires, whiskers, pellets, and the like.

c. Exemplary Split-Plasma-Based Reactions

Advantageously, the systems and methods disclosed herein can offer more precise and energy-efficient alternatives to conventional chemical processing. Examples provided below illustrate the use of these systems and methods for selective oxidation, to demonstrate the principles of the invention and the advantages that it offers for industrial chemistry. The discoveries underlying the split-stream plasma technology as disclosed herein are applicable to all systems that use plasma technologies to combine O₂ (or other oxidant) with other secondary reactants to form desirable products: only if the O₂ (or other oxidant) molecule is present in the plasma as the sole or predominant component without significant “energy theft” from other molecules can it become sufficiently activated in the plasma to permit adequate reactivity and selectivity. Under such advantageous conditions, in the absence of “energy theft” from other molecules, the activated species of oxygen can then react with other secondary reactant molecules that are brought into contact with these activated species after they have been produced. O₂'s bond structure can only be sufficiently broken when this molecule is present in the plasma alone or in such quantities that essentially the entire applied energy in the plasma is directed at and absorbed by the O₂.

While described here with particular reference to selective oxidation, it us understood that the systems and methods disclosed herein provide for both selective oxidation and selective reduction, using a split-stream plasma that separates the primary reactant (the oxidant for selective oxidation and the reductant for selective reduction) from the secondary reactant (the oxidized species or the reduced species), energizes the primary reactant, and directs the energized species of the primary reactant to contact the secondary reactant. The secondary reactant can remain unenergized to contact the energized primary reactant, or it can be energized separately as a plasma, which can be advantageous under certain circumstances. However, the secondary reactant is not energized in a mixture with the primary reactant. The primary reactant and the secondary reactant are kept separate until after the primary reactant has been energized, following which the energized primary reactant is directed to contact the secondary reactant to form the desired products.

For illustrative purposes the following exemplary uses of the split-plasma-based reactions for selective oxidation are set forth below, to offer alternatives to or variants of (i) water-gas-shift reactions (WGSR) and steam-methane-reforming (SMR), (ii) conventional partial oxidation reactions, and (iii) halogenation reactions.

i. Water-Gas Shift Reactions and Related Reactions

In embodiments, hydrogen peroxide or water vapor can be used as an oxidant in accordance with the inventive systems and methods. When these molecules are activated in a non-thermal plasma, they provide a source of activated hydroxyl species that can interact with a secondary reactant (e.g., a hydrogen source molecule such as methane, an alkane, an alkene, an alkyne, or an aromatic hydrocarbon, or an oxygen-containing hydrocarbon such as an alcohol, a glycol, an ether, a phenol, aldehyde, a ketone, and the like, optionally including other functional groups and/or heteroatoms) to produce oxygenates. In this situation, one or more of the hydrogens on a carbon backbone of a secondary reactant can be replaced by one or more hydroxyl groups, converting the secondary reactant into more polar molecules and/or reaction products that are suitable for further reactions.

As an example, an activated water vapor plasma can be used as an oxidant. When subjected to activation in a NTP, the water vapor collides with electrons in the plasma to undergo elementary reactions such as those set forth in EQ20-EQ23:

e+H₂O→OH*+H*+e EQ20:

e+H₂O→H₂O*+e EQ21:

e+H₂O*→H₂O⁺+2e EQ22:

H₂O+H₂O*⁺→OH*+H₃O⁺ EQ23:

In addition to hydroxyl radicals, both vibrationally excited and cationic water (and hydronium ions) exist in abundance in such a plasma. Hydroxyl radicals are potent oxidizers given the high bond dissociation energy of water. These activated species can be directed to react with carbon monoxide as a secondary reactant, producing CO₂ and H₂ and thereby replicating those conventional reactions produced in water-gas shift reactions (WGSR), as shown in the following EQ24:

CO+H₂O [symbol] CO₂+H₂ EQ24:

Using the systems and methods of the present invention, selective activation of a water vapor plasma can offer an alternative approach to conventional WGSR that avoids the limitations of this industrial reaction using the selective oxidation, CO can be converted into CO₂ and H₂ using a technology that proceeds at extremely high rates, can be catalyst-free, is unhindered by thermodynamic/kinetic conflict, is precisely and instantaneously tunable, is operational at modest (e.g., close to ambient or moderately higher) temperatures, and that restricts reverse reactions as would occur with conventional WGSR processes.

In more detail, separating the WGSR reactants (CO and H₂O) and energizing only the water in the plasma results in superior conversion and energy efficiency. After the water vapor species are activated in the plasma, they are directed to collide with a stream of carbon monoxide (the secondary reactant) that is ejected from a nozzle or multiple nozzles placed in proximity to the activated reactor effluent. The interaction of the energized effluent (i.e., the activated water vapor species, acting as primary reactant) and the carbon monoxide stream (the secondary reactant) takes place in the reaction zone, as described above. Residence time of the energized primary reactant (water vapor) and secondary reactant (carbon monoxide) in the reaction zone can be tuned and optimized by gas flow patterns and mixing chamber geometry. The rate of conversion can be dynamically tuned by the incident power to the plasma chamber, the relative flow rates of the primary and secondary reactants co, the operating pressure (thus frequency of collision), the size of the reaction zone, and detailed fluid flow patterns (vortexed vs. non-vortexed, co-planar vs. cylindrical, and coaxial vs. counter-current mixing, and the like).

Without being bound by theory, it is envisioned that, upon collision, the oxygen atom of the hydroxyl radical attaches itself to the carbon of carbon monoxide spontaneously, while forming a new, strong C—O bond (thus creating CO₂) and simultaneously ejecting a hydrogen atom. This newly released hydrogen radical quickly finds another hydrogen radical in the reactor effluent to pair with, thereby forming a hydrogen molecule. As the combined gaseous stream (now containing newly formed CO₂) is pumped away from the interaction zone, the mixture temperature quickly quenches, minimizing the tendency for CO₂ to decompose to cause the reverse reaction. Temperature quenching can be achieved by various means including an expanding nozzle, cooling coils, or injection of an inert species downstream of the reaction zone. The combined stream, containing the CO₂ and H₂ products, can optionally be bubbled through an alkaline solvent (or aqueous solution) to sequester CO₂ from the product mixture.

As another example, highly active hydroxyl and hydrogen radicals formed by energization of a water vapor plasma can be used for selective redox reactions involving hydrocarbons such as methane. When methane is the secondary reactant, the hydroxyl and hydrogen radicals can directly extract a hydrogen from methane to form a hydrogen molecule, and can attach a hydroxyl to the carbon of methane to form methanol. Further exposure of the methanol product to the activated species from the water vapor plasma will convert methanol to carbon monoxide (i.e., following an oxidation ladder) while releasing yet more hydrogen. Once methanol is formed, further conversion of it into carbon monoxide and hydrogen is akin to running the well-known hydrogenation process in reverse. Decomposition of methanol (in the vapor state) to form carbon monoxide and hydrogen under the continued bombardment of energetic water molecules and various radicals emitted from the plasma zone is energetically near neutral but entropically very favorable. Therefore, one can arrest methane conversion at the stage of methanol by shortening the residence time of methane in the plasma “tail” ejected from the plasma. Alternatively, if one wishes to produce syngas preferentially, then the residence time in the reaction zone can be prolonged to cause further oxidation of methanol to form carbon monoxide and hydrogen.

Besides offering a scheme for forming methanol, the selective redox systems and methods disclosed herein provide a pathway for converting methane into CO, thus offering an alternative to conventional processes, including steam-methane reforming (SMR), dry reforming (DR), and partial oxidation (PO), represented respectively, by the following equations EQ25-27:

CH₄+H₂O=CO+3H₂ ΔH=+206 KJ/mol (SMR) EQ25:

CH₄+CO₂→2CO+2H₂ ΔH=+247 kJ/mol (DR) EQ26:

CH₄+1/2 O₂→CO+2H₂ ΔH=−36 kJ/mol (PO) EQ27:

In each case, drawbacks to conventional processes are well-known in the art. Large installations are typically required, with high operating temperatures and pressures and reliance on catalysts. In each case, the use of water vapor plasma offers systems and methods of the present invention offer an attractive alternative. Without limitation, these systems and methods can offer (1) small installations that can be built at numerous sites to ensure supply chain robustness and product distribution logistics simplification, (2) low operating temperatures and pressures, (3) extremely high energy efficiency, approaching thermodynamic theoretical minimums, (4) option for catalyst-free operation, (5) stable and reliable reactions with parameters selectively and near-instantaneously tunable, for example to shift from hydrogen predominance in the product stream to methanol; and output selectivity instantaneously tunable (e.g., shifting the product split from hydrogen to methanol), and (6) highly controllable operation, with reactions that are fundamentally continuous, but can be shut down and re-started on demand.

ii. Alternatives to Conventional Methods for Partial Oxidation Reactions

As described above, the selective redox processes disclosed herein can flexibly process variable feedstocks, and offer alternatives to conventional methods for partial oxidation reactions. For example, if other volatile hydrocarbons are used as secondary reactants instead of methane, the selective redox reactions can produce higher alcohols, with companion hydrogen generation. Further bombardment by activated species can convert the alcohols into aldehydes or ketones, with more release of hydrogen. In other words, we have a fundamental process for hydrogen generation, with companion alcohol/aldehyde/ketone creation.

In another example, oxygen can be combined with water vapor as feedstock for the NTP. Multiple activated species are formed by these two components, as illustrated by the following equations EQ28-EQ32 for the water vapor and EQ33-EQ38 for the oxygen:

e+H₂O→OH*+H*+e EQ28:

e+H₂O→H₂O*+e EQ29:

e+H₂O*→H₂O++2e EQ30:

H₂O+H₂O*⁺→OH*+H₃O⁺ EQ31:

H₂O+M*→OH*+H+M, where M is produced by the reaction shown in EQ28 EQ32:

O₂+e→O⁺+O+2e EQ33:

O₂+e→O⁻+O EQ34:

O+O₂→O₃ EQ35:

O+H₂O→2OH* EQ36:

O₃+OH⁻→HO₂⁻+O₂ EQ37:

O₃+HO₂⁻→OH*+O₂⁻+O₂ EQ38:

As can be seen in the reactions above, a number of activated oxidizing agents are produced in a NTP formed from an oxygen/water vapor mixture, which can then be used effectively for oxidizing secondary reactants in a split-plasma system to produce oxygenates. The mixture of H₂O and O₂ can be tuned so that the desired mix of activated species are produced in the plasma to interact with the secondary reactants and yield the intended selective oxidation products.

Based on this discovery, these systems and methods can introduce two separate streams into a system comprising a reactor that energizes O₂ or another oxidant in a NTP as the primary reactant, and that directs the energized primary reactant to interact with a separate secondary reactant (e.g., a hydrogen source such as methane, an alkane, an alkene, an alkyne, or an aromatic hydrocarbon, or an oxygen-containing hydrocarbon such as an alcohol, a glycol, an ether, a phenol, aldehyde, a ketone, and the like, optionally including other functional groups and/or heteroatoms) in a reaction zone outside the plasma zone, so that (i) the oxidant (e.g., O₂) stream is directed into a region of high field-intensity to create and sustain it as a plasma, while (ii) a secondary reactant is shielded from the exposure to high-field intensities or is activated in a separate region of high fields. Using O₂ as an exemplary oxidant, the systems and methods disclosed herein excite the O₂, which then emerges from the plasma zone as activated species that collide with the secondary reactant, triggering a cascade of combination/rearrangement reactions that ultimately lead to the interaction of the secondary reactant and the plasma-activated oxygen outside the plasma energy zone to convert the secondary reactant into the higher-value products.

The split-stream plasma-based system therefore allows the co-reaction of O₂ (or other oxidant) with an unlimited number of secondary reactants, such as substituted or unsubstituted branched or unbranched saturated hydrocarbons including without limitation alkanes or paraffins of various sizes and structures, such as methane (CH₄), ethane (C₂H₆, CH₃CH₃), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules, unsaturated compounds such as alkenes and alkynes, and aromatics, for example, with insertion of oxidant-derived polar group into these starting secondary reactants to form oxygenates such as methanol, ethanol, dimethyl ether, formaldehyde, acetaldehyde, and other alcohols, aldehydes, ethers, esters, ketones, epoxides, and organic acids, all with or without heteroatoms.

These systems and methods offer partial oxidation mechanisms that form oxidized products from methane or other volatile hydrocarbons while avoiding excessive oxidation with combustion and CO₂ formation. For example, oxygen can be used as the primary reactant and combined with methane as the secondary reactant to yield CO, as an alternative to conventional partial oxidation mechanisms. Similarly, using oxygen as the primary reactant and combining it with other volatile hydrocarbons, products such as methanol (or higher alcohols), formaldehyde (or higher aldehydes), or olefins can be formed. Parameters such as power input, relative flow rates of oxygen and hydrocarbon, geometry of the injector nozzles, flow vortices, and contact duration of the primary and secondary reactants in the reaction zone can be adjusted and tuned, depending on the desired products to be formed. The selective oxidation products can form within the system wherever the secondary reactant molecules encounter the activated oxygen species produced by the plasma, whether within the less energized regions of the plasma reactor itself, or external to the reactor as the activated oxygen species exit the reactor. The selective oxidation products can be entrained in a fluid stream (i.e., liquid or gaseous) of effluents, which can include the desired chemical product(s), other reaction products, and unreacted O₂ and secondary reactants. The desired chemical product(s), carried within the effluent fluid stream, can be transported away from the reaction zone within the effluent stream, and the effluent stream can undergo further separation using conventional separation techniques to isolate its various components, including the desired chemical product(s).

If the desired reaction is a simple one, for example, between O₂ and a lower alkane such as methane, the product stream is relatively simple, containing the desired product (such as methanol) and some unreacted reactants. If the desired reaction is between O₂ and a more complex secondary molecule, whether a hydrocarbon or a heteroatom-containing molecule or otherwise, the product stream can include a spectrum of reaction products derived from the insertion of oxygen species into one or more areas of the secondary reactant molecule, and can further include unreacted O₂ and unreacted secondary reactants. While it is understood that the activated oxygen species can be inserted in any location along the secondary reactant to form a mixture of desirable and undesirable products, if the secondary reactant is differentially activated there can be fewer reactive species interacting, allowing for greater selectivity and higher yield for the desired high-value product(s): since the secondary reactant molecule is not itself energized in the same plasma, it has fewer opportunities to form undesired hydrocarbon reaction products that can subsequently combine with themselves or with the oxidant.

As mentioned previously, this restriction does not mean that O₂ (or other oxidant) must be the only component in the plasma feed. Moreover, in certain embodiments, O₂ can be advantageously combined in a plasma with an inert gas such as helium, neon, or argon to tune the excitation characteristics of the plasma. These co-components in the plasma can facilitate the breakdown of O₂ by the NTP as the energetic (but unreactive) helium, neon, or argon can collide with O₂ in the plasma. However, these co-components are not required for effective plasma-driven selective oxidation, as the energized oxygen or other oxidant alone is sufficient to interact with the differentially activated secondary reactants to produce higher-value compounds (e.g., alcohols, aldehydes, ethers, esters, ketones, epoxides, and organic acids), or to interact with other heteroatom-containing secondary reactant molecules to produce more complex chemicals. For example, using the techniques described herein, oxygen can be used as the oxidant to produce amino acids from amines.

In embodiments, oxygen can be as an exemplary reactant to illustrate the systems and methods disclosed herein, which: (i) split the intended reactants into two streams, a primary reactant stream comprising or consisting essentially of the more difficult-to-activate main molecule (e.g., oxygen), and a secondary reactant stream that comprises the secondary substance(s) intended to react with the main molecule, (ii) activating the primary reactant stream and (iii) then recombine these two streams. In more detail, the main reactant stream is introduced into the region of high field intensity to create and sustain a plasma, while the secondary reactant stream is shielded from the high field intensity and is directed to interact in an unactivated state or less activated state with the activated species of the main molecule. In an illustrative embodiment, the main reactant molecule is O₂, and the secondary reactant is a carbon-containing hydrogen source (e.g., a hydrocarbon such as methane, an alkane, an alkene, an alkyne, or an aromatic hydrocarbon, or an oxygen-containing hydrocarbon such as an alcohol, a glycol, an ether, a phenol, aldehyde, a ketone, and the like, optionally including other functional groups and/or heteroatoms). The O₂ is then utilized in the system to form more complex products such as oxygenates that are derived from the insertion of the activated oxygen species into the secondary reactant as a substitution reaction, an addition reaction, an elimination reaction, a rearrangement reaction, or the like, or combinations thereof, or to form higher-order hydrocarbons. In embodiments, a wide variety of products can be formed, including without limitation, unsaturated aliphatic hydrocarbons, such as alkynes and alkenes (including olefins); saturated hydrocarbons (e.g., alkanes, paraffins); cyclic and polycyclic hydrocarbons including aromatic compounds; heterocyclic compounds; and wide spectrum of other oxygen-containing organic compounds such as alkanols (such as monohydric (CₙH₂ₙ₊₁OH), diols or polyols, unsaturated aliphatic, alicyclic, and other alcohols having various hydroxyl attachments); nitroalkanes such as nitromethane (CH₃NO₂); carbohydrates; and the like.

Whether the activated oxygen species react with less complex or more complex secondary reactants, the resultant product stream can be separated into its components using conventional techniques, e.g., liquefaction, pressure swing adsorption, membrane cartridges, absorption/desorption, and the like, so that the desirable reaction product(s) are separated from the other reaction products and the unreacted species. The separated streams can be commercialized separately, and/or recycled back into the system to optimize utilization of the feedstock.

In certain of systems and methods described herein, a common feature is the use of the O₂ or O₂-predominant or other oxidant feedstock as the source of the activated species for producing reactions; the non-thermal plasma is imposed only on this feedstock and not on the secondary reactants. Within the reactor system as a whole, a stoichiometrically advantageous reactant ratio is produced by introducing appropriate quantities of the differentially activated secondary reactant (e.g., a hydrogen-rich source stream) that can interact with the activated oxygen species. In addition, desirable molecular recombinations involving the activated species and the secondary reactant are facilitated by introducing the secondary reactant into the reactor system at strategic locations and under strategic conditions.

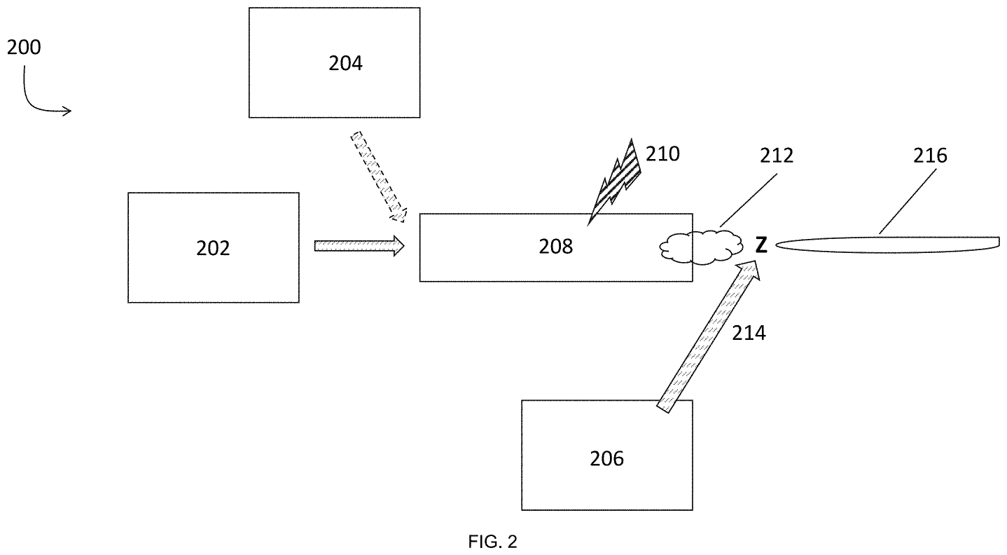

FIG. 2 depicts a block diagram that shows certain features of the systems and methods disclosed herein. While O₂ is described as an exemplary oxidant in connection with the Figures that follow, it is understood that any oxidant can be used in keeping with the systems and methods disclosed herein. FIG. 2 depicts an exemplary system 200 for the use of O₂ or other oxidant to form higher-value products, comprising a O₂ or other oxidant source 202 that feeds O₂ or other oxidant into a plasma reactor 208 energized by an energy source 210. The O₂ or other oxidant stream can be accompanied by an optional gas stream 204 comprising gases such as inert or noble gases that can act as co-components to facilitate the breakdown of O₂ or other oxidant within the plasma chamber 208. As the O₂ or other oxidant encounters the energy in the plasma reactor 208, it is energized to form a plasma, and it exits the plasma reactor 208 as activated oxygen species 212. A hydrogen source 214 provides a supply of a secondary reactant, for example hydrogen source molecules, to interact with the activated oxygen species 212. The secondary reactant 214 can be delivered through a conduit (not shown) to a designated reaction zone Z, for example where the activated oxygen species 212 emerge from the plasma reactor 208. As used herein, the term “conduit” can refer to any mechanism, structure, chamber, compartment or region through which a secondary reactant is delivered to a designated area or reaction zone Z where it can interact with the activated oxygen species (or other oxidant). A conduit can be a tube, hose, spout, nozzle or the like through which the secondary reactant flows, or it can be a cylinder surrounding or internal to the plasma reactor 208; in other embodiments, where the plasma reactor includes a planar structure such as a plate or where the plasma reactor permits the formation of multiple plasma zones with the interstices of a matrix, the conduit can itself be planar, for example, permitting the deployment of the secondary reactant across a flat or shaped surface so that it comes into contact with the activated oxygen species as either the secondary reactant or the activated oxygen species passes through pores, voids or other channels.

The reaction between the activated oxygen species 212 and the secondary reactant 214 yields a product stream 216 comprising higher-value compounds that result from the selective oxidation. While FIG. 2 depicts the collision between the activated O₂ or other oxidant species 212 and the secondary reactant taking place at the distal end of a plasma reactor 208 as the activated oxygen 212 exits the plasma reactor, it is understood that the secondary reactants and the activated O₂ or other oxidant species can be directed towards each other at any convenient location for interaction, i.e., in any reaction zone Z, provided that adequate energy of the activated oxygen species is retained.

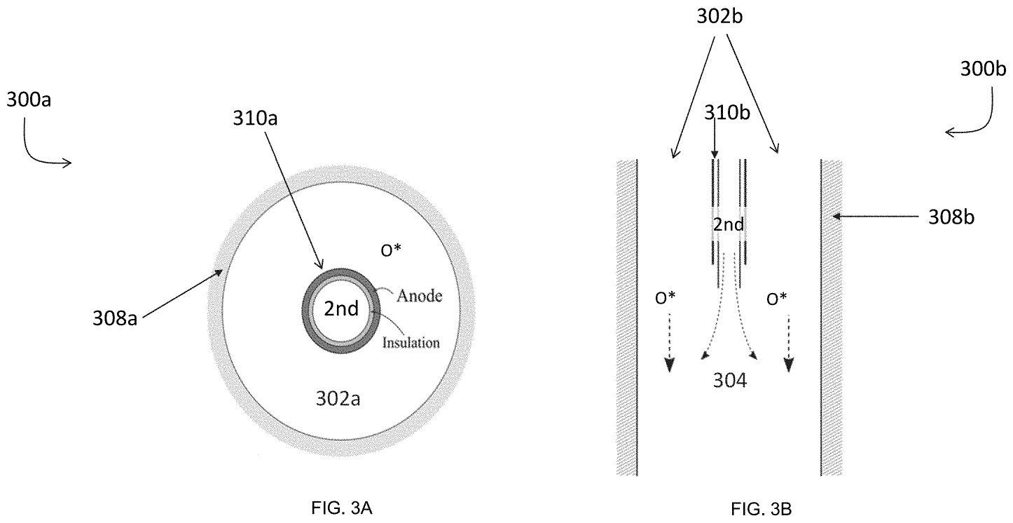

An alternate embodiment is depicted schematically in FIG. 3A and FIG. 3B, which shows systems 300a and 300b in which two conduits are coaxially arranged. The inner conduit (310a and 310b) contains the secondary reactant (designated in the Figure as 2nd), which can be any hydrogen source molecule, as previously described. The outer conduit (308a and 308b) conveys the primary reactant to become activated. In the depicted embodiment, the conduit conveying the secondary reactant is maintained within the O₂ or other oxidant-containing structure and is insulated from the plasma-producing energy, while the plasma-producing energy is limited to the structure that confines the O₂ or other oxidant, i.e., the conduit 308a and 308b. In the system shown in FIGS. 3A and 3B, the O₂ or other oxidant stream (designated as O in the Figure) and the secondary reactant stream (designated as 2nd in the Figure) are kept separate from each other. In these Figures, the conduit 310a and 310b containing the secondary reactant stream 2nd is contained within an outer cylinder 308a and 308b that houses the plasma reaction, while being separated and insulated from the plasma produced in the outer cylinder 308a and 308b.

In the system 300a (depicted in cross-section in FIG. 3A), the anode (“Anode”) for the plasma reactor is disposed on the outer aspect of the secondary reactant conduit 310a, creating the field of high energy intensity 302a within the O₂ or other oxidant-containing cylinder 308a to energize the O₂ or other oxidant (with O₂ or other oxidant represented by O in this Figure and activated oxygen or other oxidant and its dissociation products represented by O* in this Figure), but with an insulation layer (“Insulation”) disposed internal to the anode shielding the secondary reactant from the field of high energy intensity. In the aspect of the system 300b shown in longitudinal section in FIG. 3B, the activated O₂ or other activated oxidant species (represented by O* in this Figure) continues to pass through the O₂ or other oxidant-containing structure 308b to encounter the unactivated secondary reactant 2nd as the latter emerges from the distal end of its own conduit. Because the anode ends at the end of the secondary reactant conduit, the plasma formation ceases at that level, and the activated oxygen (produced by the plasma) and the secondary reactant (insulated from by the plasma) encounter each other in a reaction zone 304 that is not affected by the more proximal area of high plasma energy 302b.

In embodiments, the activated O₂ or other activated oxidant species pass into the conduit where the secondary reactant is located; in other embodiments, the activated oxygen and the secondary reactant can encounter each other through diffusion, whereby the secondary reactant is introduced into a low-energy field that is adjacent to but insulated from the high-energy field where the activated O₂ or other activated oxidant species are flowing, with the two reactants being separated from each other by a porous barrier that allows passage therethrough. The planar area across which the secondary reactant flows can be termed a “conduit” for this material. In embodiments, the activated O₂ or other oxidant can pass into the compartment (i.e., the conduit) where the secondary reactant is flowing.

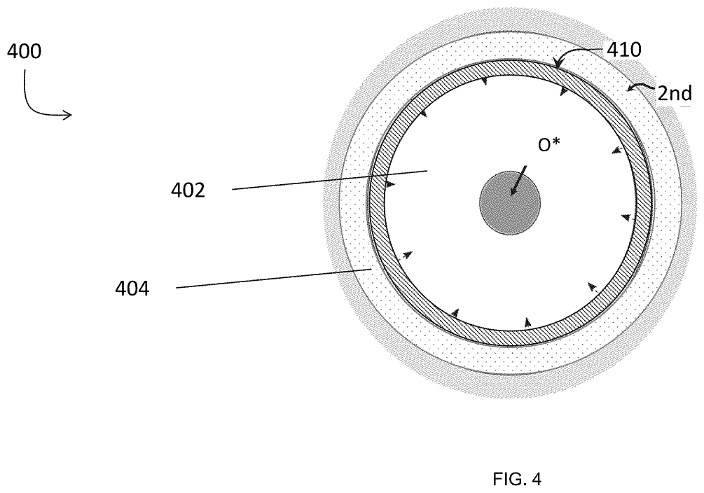

In embodiments, the activated O₂ or other activated oxidant species pass into the conduit where the secondary reactant is located; in other embodiments, the secondary reactant passes into the compartment where the activated oxygen species are being or have been generated. FIG. 4 provides a depiction of such an arrangement. FIG. 4 depicts schematically a cross-section of a system 400 in which the activated O₂ or other activated oxidant species (designated in the Figure as O*) is generated within a central O₂ or other oxidant-containing chamber 402 (with O₂ or the other oxidant designated by O in this Figure) that contains the high-energy field, while the secondary reactant (designated in the Figure as 2nd) flows through a peripheral conduit 404 that partially or completely envelopes the central plasma chamber 402. An insulating but porous wall or membrane 410 isolates the secondary reactant 2nd from contact with the high energy field and separates the secondary reactant 2nd from the activated O₂ or other activated oxidant species; however, the porous nature of the wall or membrane 410 allows the influx of the secondary reactant 2nd (which influx is represented by the plurality of small arrows pointing towards and surrounding the central conduit) to contact the activated O₂ or other activated oxidant species outside the plasma zone or at the lower-energy periphery of the plasma zone, where the two reactants commingle and interact to form higher-value selective oxidation products.

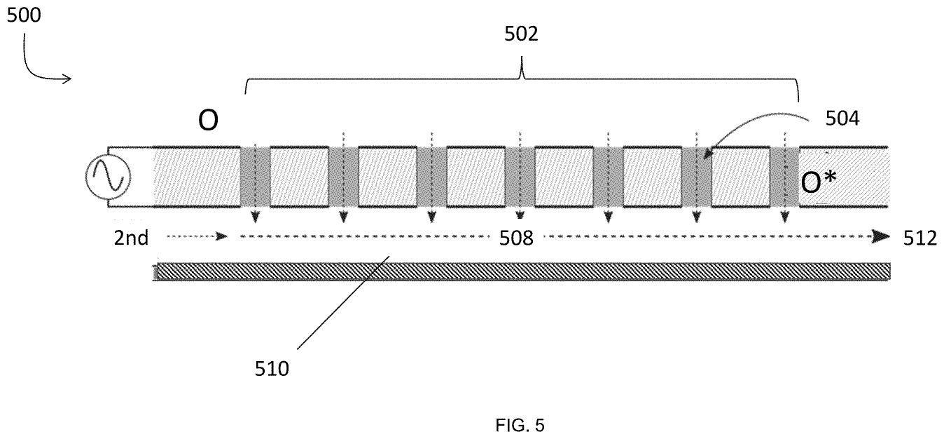

In an alternate embodiment, a series of separate high-energy regions can be created to energize O₂ or other oxidant to form a plasma, for example, in an array or a matrix, with the O₂ or other oxidant being directed into these high-energy regions to be converted into activated oxygen or other activated oxidant species O*. A representative embodiment is depicted schematically in FIG. 5. As shown in this Figure, a system 500 is shown in cross-section, wherein a flow of O₂ or other oxidant gas 502 is directed into a plurality of high-energy regions 504 where the O₂ or other oxidant gas (designated as O in this Figure) is formed into a plasma, producing the activated O₂ or other activated oxidant species O*. The activated O₂ or other activated oxidant species O* emerge from the high-energy regions 504 to encounter a flow 508 of a secondary reactant, e.g., hydrogen source molecules (designated as 2nd in the Figure) within a secondary reaction conduit 510. The interaction of the O* and the 2nd produce the desired product 512, which emerges from the secondary reaction conduit 510 to be separated from any other substances by conventional separation techniques (not shown).

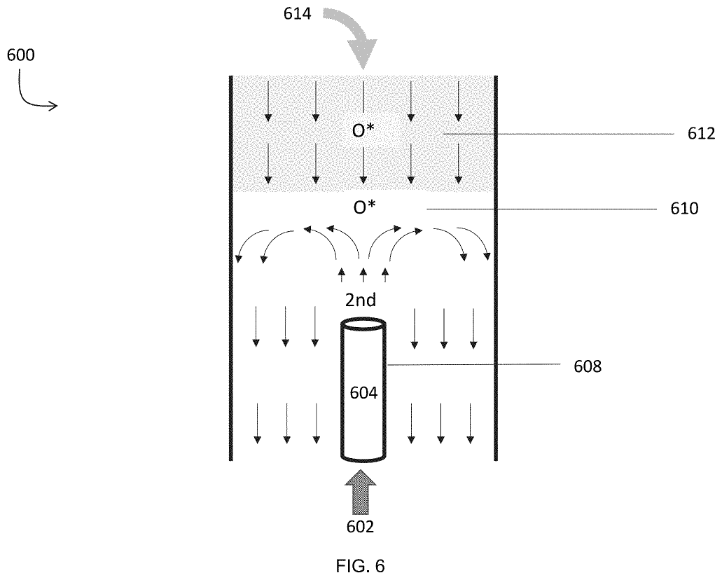

In yet another embodiment, as shown in FIG. 6, a system 600 is shown in cross-section, wherein a flow of O₂ or other oxidant source gas 614 is directed into a high-field area 612 in which the O₂ or other oxidant is formed into a plasma, producing activated O₂ or other activated oxidant species (designated as O* in this Figure). In the plasma system 600 depicted in FIG. 6, a feed gas stream 602 comprising one or more secondary reactants in a secondary reactant stream 604 is directed through a secondary reactant injector 608. Such secondary reactants (designated in this Figure as 2nd) enter the reaction zone 610 to encounter the activated O* species being expelled from the high-field region 612. The gas stream comprising the secondary reactant(s) 604 can also include other, non-reactive gases and/or gases that are not considered secondary reactants. Moreover, while a single feed gas stream 602 is shown entering a single secondary reactant injector 608 to direct a single secondary reactant stream 604 into the reaction zone 610, it is understood that a plurality of secondary gas streams can converge and be mixed in a single secondary reactant injector 608 to produce the single secondary reactant stream 604 contained therein. It is further understood that the secondary reactants 2nd in the reaction zone 610 can be provided by a plurality of secondary reactant injectors, each of which delivers one or more secondary reactants 2nd into the reaction zone 610. In the depicted embodiment, the secondary reactant stream 604 is directed from the secondary reactant injector 608 towards a reaction zone 610, where the secondary reactants 2nd interact with plasma-activated O₂ or other oxidant O*.

As shown in this Figure, the O* that interacts with the 2nd has been formed from a source gas 614 comprising O₂ or other oxidant where the O₂ or other oxidant entrained in the source gas 614 is energized in the high-field region 612 to form the O*. It is understood that the source gas 614 can comprise other reactive or non-reactive gases, such as, without limitation, helium, neon, argon, and the like. The plasma that energizes the O₂ or other oxidant to produce O* in the high-field region can be produced by any of the plasma-producing methods familiar in the art (e.g., produced by microwaves, radiofrequency, DBD, etc.).

The system 600 is designed so that the O* is directed to encounter the oncoming stream of the secondary reactant 2nd in the reaction zone 610, with the desired product(s) (not shown) being formed in the reaction zone 610 initially by the interaction of the O* and the 2nd. The reaction zone 610 is situated just outside the high-field region 612 between the outflow tract for the 2nd from the secondary reactant injector 608 and the outflow tract for the O* from the high field region. This location of the reaction zone 610, outside the high-field region and between the high-field region 612 and the distal end of the secondary reactor 610, allows products (not shown) to be produced that are not themselves affected by the plasma energy in the high-field region 612. Such products as are formed in the reaction zone 610 can be recovered from this location and can be further separated from each other using conventional separation techniques (not shown), allowing desirable products or their precursors to be isolated for further processing.

The position, diameter, and temperature of the secondary reactant injector 608 as well as the flow rates and direction of the O* and the secondary reactant stream 604 are chosen to achieve a desired flow pattern where the secondary reactant or reactants 2nd do not enter the high-field region 612 but rather encounter the activated O* in the reaction zone 610. Concomitantly, process parameters are selected so that the activated O* does not decay before it can react with the secondary reactant(s) 2nd in the reaction zone. Injector designs for the O₂ and secondary reactant streams can be selected in particular to arrange advantageous flow patterns of the activated O* and the secondary reactants to optimize their interaction with each other, for example vortices or other specially designed flow patterns. An embodiment of a flow pattern is schematically suggested by the arrows in the Figure, but it is understood that other flow patterns can be designed by artisans of ordinary skill using no more than routine experimentation.

As described above, selective oxidation can be performed using other oxidants besides O₂. For example, carbon-containing compounds such as carbon monoxide or lower-chain hydrocarbon oxygenates such as acetone or ethanol, or other alcohols, aldehydes, or ketones can be used as oxidants. In an embodiment, when a plasma is formed from carbon monoxide, it can be directed at selected secondary reactants to form useful products. When water vapor is used as a secondary reactant, its encounter with plasma-energized carbon monoxide can create formic acid. When methanol or ethanol are used as secondary reactants instead of water vapor, the corresponding formate esters are produced.

In other examples, heteroatom-containing organic molecules or inorganic molecules such as SO₂ or H₂S can be used as oxidants. If sulfur dioxide is used as the oxidant, sulfoxyls can be formed, or if H₂S is used as the oxidant, thiols can be formed. In a preferred embodiment, halogen-containing molecules can be used as oxidants for halogenation reactions, as described below in more detail.

iii. Halogenation Reactions

In embodiments, the systems and methods disclosed herein can use halogens as oxidants; the split-stream plasma systems of the present invention can therefore produce valuable products such as vinyl chloride monomers, halogenated aromatics, and the like from plasma-based halogenation of carbon-containing secondary reactants. In the description that follows, X is used to represent a halogen atom, either as a counterion X⁻ in an HX molecule or as a diatomic halogen molecule X₂, which can be used as a primary reactant (oxidant) in the split-stream plasma systems and methods of the present invention.

For halogenation reactions, it is understood that both halogen molecules (either as HX or X₂) and hydrocarbon molecules (HC) are relatively reactive. However, if both species are added in the same plasma, both the halogen and the HC would be energized, leading to a multitude of simultaneous halogenation reactions in the plasma stream, which would make product selectivity and separation difficult. To optimize the yield of specific desired halogenated products, the split-stream plasma approach as described above can be employed, with the HX/X₂ selected as the primary reactant, and the HC selected as a secondary reactant. Consistent with the principles of the invention, the HX/X₂ and the hydrocarbon are separated, with the HX/X₂ being introduced into the region of high field intensity to create and sustain a plasma as the primary reactant, while the HC is maintained as a separate stream that is not subject to the energization that is used to form the HX/X₂ as a plasma. Then, as previously described, the activated primary reactant (here, the plasma formed from the HX/X₂) is directed to interact with the secondary reactant (here, the HC). As previously described, the HC can either remain unactivated prior to its encounter with the HC or it can be activated separately, provided that the energized HX/X₂ plasma is isolated from the activated HC before they are directed to react with each other. Upon exiting the plasma chamber, the activated halogen (or HX) “tail” is made to collide with a stream of hydrocarbon gas ejecting from a nozzle (or multiple nozzles) placed in proximity to the reactor effluent. The energized effluent and the hydrocarbon stream then interact with each other in the reaction zone. Residence time of the two ingredients in the reaction zone can be tuned and optimized by gas flow patterns and mixing chamber geometry. The rate of conversion can he dynamically tuned by the incident power to the plasma chamber, the relative flow rates of the primary and secondary reactants the operating pressure (thus frequency of collision), the size of the interaction zone, and detailed fluid flow patterns (vortexed vs. non-vortexed, co-planar vs. cylindrical, and coaxial vs. counter-current mixing, and the like)

Involving two separate streams, the process allows the parameters of each to be tuned, along with the parameters for their mixing following activation of the halogen stream in the plasma. Such tuning can take place dynamically in real time and on-the-fly, as reaction conditions and product compositions demand. For example, the incident power to the plasma chamber (which determines the activated species concentration), the relative flow rates, and the process pressure can be varied, as can the inclusion of other non-halogen gases (e.g., inert gases, such as nitrogen, helium, argon, and neon) to tune the composition of the activated species. As another example, the relative relationship of the plasma stream and the secondary reactant stream can be adjusted, e.g., sliding the outlet nozzle of the shielded hydrocarbon target gas (or liquid) closer to or farther away from the plasma jet. Most notably, the product can be much more uniformly halogenated (e.g., the degree of substitution per hydrocarbon molecule from mostly mono- to di, to tri, to multi-substituted, etc.) as the process is continuous from the perspective of the co-reactants.

While gaseous secondary reactants are advantageous to employ, in other embodiments, a non-volatile or low-volatility reactant liquid or solid can be introduced as secondary reactants into the reaction zone. The liquid can be a thin recirculating/stirred pool or can be atomized into small droplets to enhance surface area for plasma contact. A solid can similarly be aerosolized and suspended in a gaseous or liquid fluid to optimize its presentation for reaction.

Halogenation of alkanes is an advantageous application of these systems and methods, in which one or more alkanes are the secondary reactants that are exposed to the activated halogen stream. On each secondary reactant molecule, the site distribution of halogenation is related to the collision cross-section of the available hydrogen for replacement, a feature that differentiates the product composition profile from these processes from the product distribution and yield obtained from conventional processes.

This ability to select for narrower product profiles renders these systems and methods especially advantageous for application to higher alkanes. It is known that halogenated alkanes can be converted to the corresponding alcohols via heating in basic solution and more complex alcohols can be formed by the Grignard reaction. The systems and methods according to the present invention can overcome the thermodynamic restrictions (e.g., the possibility for reaction reversal) of conventional processes, since the desired combinations occur during the brief residence time when the activated halogen encounters the alkane secondary reactant in the reaction zone: using the systems and methods disclosed herein, as soon as the combined reactant/product stream transits through the highly confined reaction zone towards the product harvest point, the medium temperature cools down precipitously and the reaction self-quenches, locking in the reaction zone exit-point product profile. This leads to a more desirable product profile and substitution uniformity for halogenation of alkanes using these systems and methods as compared to conventional processes.

Halogenation of alkenes presents another advantageous application of these systems and methods. A plasma using HX/X₂, (with optional co-feed of inert gases, such as nitrogen, helium, argon, and neon to tune the characteristics of the plasma) can react readily with olefins, leading to substitutions at saturated or unsaturated carbon sites on these molecules. While unsaturated sites can be selected for substitution (as in the halogenation of ethylene using these systems and methods, as discussed below), substitutions on saturated sites are preferable for higher alkenes. Without being bound by theory, it is envisioned that the systems and methods of the present invention can preserve the double bonds in the secondary reactant alkenes due to the very brief encounter between the activated halogen species and the secondary reactants, such that substitution reactions only take place at the precise points of collision between the primary and secondary reactants. Thus, for higher alkenes, the double bonds in the alkenes can be preserved with direct monohalogenation of the C═C double bond, with resulting products that are mostly halogenated alkenes.

The halogenation of ethylene represents an important application of the systems and methods disclosed herein. Using the principles of the invention, direct monohalogenation (e.g., monochlorination) of ethylene can he accomplished, while preserving the C═C double bond. In other words, these processes can extract a hydrogen atom from a carbon atom associated with a pi-electron-rich C═C double bond, and can replace it with a Cl atom or other halogen atom; moreover, these processes, with appropriate tuning, can extract more than one hydrogen atom and replace them with halogen atoms, all without destroying the C═C double bond. This process can accomplish these unusual end-results because it does not rely on traditional mechanisms for effecting such substitutions, such as catalytic surface-mediated bond weakening to permit substitution, or homogenous catalysis, or the electrophilic tendency of halogens themselves.

The use of these methods allows, for example, the single-step formation of vinyl chloride monomer (VCM). As described above, an energized plasma can be formed using either a Cl₂ or an HCl vapor plasma that can be directed to encounter unactivated ethylene as the secondary reactant. This reaction will form monochlorinated ethylene, i.e., VCM. In addition, dihalogenation or higher degrees of substitution—without destroying the double bond—can be produced by increasing the plasma input energy and/or changing the relative flow rates of the primary and secondary reactants, thus producing vinyl dichloride and vinyl trichloride and fully chlorinated vinyl monomers, which then can be used for the formation of appropriate thermoplastics. While the example of VCM has been described in detail, it is understood that these methods can be applied as well to bromination reactions. Using ethylene as a secondary reactant but using Br, or HBr as the primary reactant to be energized, these processes produce vinyl bromide and higher bromo-substituted vinyls.

Halogenated alkenes of various configurations produced in accordance with these systems and methods can be used for a number of important secondary reactions. For example, halogenated alkenes are subsequently capable of free radical polymerization with traditional olefins as a co-monomer, forming polyolefins. Besides assisting with the formation of the polyolefin chains themselves, the systems and methods disclosed herein can thus facilitate the production of specialized polyolefin products. Many applications of polyolefins require modified properties, such as compatibility with polar polymers, adhesion to polar substrates, specific degrees of gas permeability, and surface wetting. Copolymerization with hydroxylated medium and long-chain olefins (in particular alpha olefins) yield these desirable properties. Alpha olefins, such as can be prepared or preserved in accordance with the principles of the invention, undergo all reactions typical of olefins: they can be used in the production of amines and amine oxides, oxo alcohols, alkylated aromatics, epoxides, tanning oils, synthetic lubricants, lubricant additives, alpha olefin sulfonates, synthetic fatty acids, and the like. Halogenated olefins produced in accordance with the present invention provides a starting point for incorporating additional functional attributes into polyolefins. As another example, halogenated alkenes can be converted into alcohols via heating in basic solution or Grignard reaction, opening a powerful synthetic avenue for important polymers and chemicals.

Hydrogen extraction and replacement with halogens on aromatic rings provides another advantageous application of these systems and methods. In accordance with the principles of the invention, an X₂ or HX primary reactant can be selected, and is energized in a gas phase plasma. The energized primary reactant can then be directed to encounter the unactivated aromatic secondary reactant, which can be a gas (vapor), a liquid mist (or thin circulating pool), or solid fine particles (carbon nanotubes or graphene). Under these circumstances, halogenation of the secondary reactant occurs, yielding products that vary in accordance with the specific secondary reactant, under conditions that allow for product selectivity.

Halogenation of aromatic secondary reactants using these methods can produce halogenated versions of such reactants that have known industrial and commercial applications. For example, halogenation of aromatic molecules can produce useful compounds more efficiently, and potentially without use of catalysts, e.g., a halogenated aromatic molecule such as tetrabromobisphenol (TBBP), a brominated flame retardant. As another example, the aromatic moieties on thermoplastic and/or thermoset polymers can be halogenated, and thus functionalized, using these methods post polymerization and/or post cure. As yet another example, halogenation of the aromatic components of nanotubes or nanoplatelets can form surface-functionalized, edge-halogenated nanoparticles that are compatible with their intended matrices, such as for attaching various sensor molecules to these functionalized nano-entities.

Recognizing the importance of halogenation reactions for industrial chemistry, those of ordinary skill in the art can identify myriad other uses and advantages to these systems and methods using no more than routine experimentation. For example, since the plasma reactor handles only one reactant (the halogen primary reactant), all of its operating parameters can be directly optimized to achieve maximal activation via decomposition of X₂ or HX into radicals and/or ions. Furthermore, since only the primary reactant is being activated, there is no need to control for potential interference with energized secondary reactant species. For example, if a hydrocarbon secondary reactant were co-present in the plasma chamber, it can degrade to form hydrogen and carbon solids and oily polyaromatic hydrocarbons, and the released hydrogen can instantly combine in the plasma chamber with activated halogen species to re-form HX, defeating the objective of halogenation. These processes further allow individual tuning of the respective flow rates, flow patterns, and interaction zone geometry, etc. for the desired reaction, and permit dynamic and rapid control of operating parameters such as the power introduced to the plasma, flow rates, distance between the plasma outlet and the configuration of the secondary reactant's entry point into the reaction zone, and the operating pressures. In addition to these sorts of hardware and operational advantages, the processes described herein are continuous, permitting rapid start-up and shut-down, thus improving product consistency, increasing plant safety, and permitting a more nuanced response to local market conditions.

Furthermore, these systems are suitable to use with or without catalysts. Within the plasma reactor, decomposition and activation of the primary reactant can be accomplished without catalysts, as can the interaction of the activated species with the secondary reactants. Optionally, however, catalysts can be employed to maximize decomposition and activation of a single reactant, such as X₂ or HX, as would be familiar to those of skill in the art. The option to use catalysts can be particularly useful under certain circumstances, for example when DBD plasmas are used.

### EXAMPLES

The exemplary embodiments are provided below to illustrate more fully the systems and methods disclosed herein.

### Example 1

### Coaxial Cylinders with a Dielectric Barrier Discharge (DBD) Reactor

In this Example, two coaxial cylinders can be configured to form a DBD reactor in which the outer electrode is a porous cylinder. This cylinder can form an electrode pair with an inner conductive cylinder, which acts as a counter-electrode. Alternatively, a tightly wrapped wire mesh or the like can be placed next to the exterior surface of the outer cylinder to function as an electrode. An annular interior chamber is positioned between the inner conductive cylinder and the outer cylinder. This coaxial cylinder arrangement is itself enclosed within an outermost chamber.

O₂ gas can flow into and through the annular interior chamber and is energized by the electrode pair of the electrode and the counter-electrode. A secondary reactant such as a hydrogen source reactant can be continuously fed into the outermost chamber to flow therethrough. The secondary reactant can also permeate the pores in the outer cylinder to enter the interior chamber, where it encounters the O₂ plasma and is immediately consumed to yield selective oxidation products via a cascade of reactive steps. Since the field intensity next to the inner cylinder is stronger than the intensity nearer to the outer cylinder, O₂ can be preferentially decomposed, forming the necessary intermediates for the intended selective oxidation reactions. The secondary reactant, its breakdown impeded by the low-field intensity in the pores of the ceramic insulator, can emerge from the cylinder wall to combine rapidly with the activated species prevalent in the annular plasma zone.

The field intensity gradient is governed by the radius ratio of the inner and outer cylinders. In addition, the feed rates of O₂ and of the secondary reactant can be individually tuned by modifying variables such as the operating pressure of the plasma zone and its cross-sectional area, the porosity/wall thickness of the outer cylinder, and the chamber pressure for the secondary reactant. The system design is flexible and can permit optimization, product selectivity and process control. Other modifications can be employed to improve efficiencies or to enhance O₂ breakdown. For example, O₂ activation and breakdown can be further expedited by bumps or patterned protrusions on the surface of the inner electrode to accentuate the local field intensity. In embodiments, the inner cylinder surface can be ridged or scalloped (parallel or perpendicular to the direction of gas flow) or wrapped with non-conductors such as glass wool.

### Example 2

### Coaxial Cylindrical Electrode Pair with Central Hollow Cylinder Electrode

In this Example, non-porous cylinders can be arranged coaxially. The inner cylinder is a hollow tube to allow flow of the secondary reactant, e.g., a hydrogen source molecule in gaseous form. While flowing in the inner cylinder, the flow of this gas is unperturbed. The outer aspect of the inner cylinder can act as an electrode. The annular region between the inner cylinder and the outer cylinder can convey O₂ therethrough, and can be configured as an electrode pair, with the outer cylinder acting as the counter-electrode to the electrode deployed on the outer aspect of the inner cylinder. The imposed electrical field within the annular region can affect the O₂ to form a plasma. As an alternative to using a DBD arrangement, a microwave-based system or other plasma generation system can be used to form the plasma within the annular region. As the secondary reactant exits the inner cylinder, it can encounter the activated oxygen species that have been formed in the plasma. In this region, the desired selective oxidation products can be formed.

The ends of the inner and outer cylinders can be designed to prevent arcing or field intensification. For example, the inner tube can have a non-conductor section that extends beyond the region defined by the coaxial electrodes. In an embodiment, a hollow metal tube can be tightly fitted with a hollow non-conductor tube inside it to form the inner cylinder assembly. The non-conductor can be longer than the hollow metal tube to extend beyond it. The distance of the extension portion of the non-conductor can be tuned, depending on relative gas flow rates and exact process conditions. Other mechanisms of gas mixing can be introduced in this section to promote collisions of molecules, free radicals, and ions, as desired. As an example, inert packing material (e.g., glass wool) or baffle/agitator designs can be positioned downstream from the distal end of the tube to facilitate mixing the activated species with the secondary reactant.

### Example 3

### Parallel Plate Reactor System with Alternating Plasma and Non-Plasma Zones

A system of alternating plasma and non-plasma zones can be arranged in zones using planar geometry. O₂ gas (or a O₂-predominant gas mixture) can be directed through a layered activation zone where it encounters plasma and is activated, and a secondary reactant gas can be directed through an adjacent non-energized layer or zone. As the gases emerge from their respective zones, they can combine to produce the desired selective oxidation products, for example, alcohols, aldehydes, ethers, esters, ketones, epoxides, and organic acids. Techniques familiar to skilled artisans can prevent reactor edge arcing and field concentration. This system advantageously allows for expansion simply by stacking additional layers and electrodes. The plasma zones can be sustained by the necessary voltage differential across the two boundary plates, while the non-plasma region can be flanked by plates that remain at the same electrical potential at all times. This design can be tailored for use with AC or DC systems for plasma production; for microwave-generated plasmas, the wave energy can be directed by waveguides to the desired (alternating) channels, for example, using striated waveguides or other designs to direct the wave energy into the desired zones for O₂ activation.

### Example 4

### O₂ or O₂-Predominant Plasma Interacting with Carbon-Containing Liquid Secondary Reactants

In this Example, plasma can be formed from gas phase O₂, while carbon-containing secondary reactants can be used in a liquid state. The O₂ plasma can be produced using any of the techniques used for plasma generation, and then the energized oxygen species can encounter the liquid secondary reactants. This encounter can take place within the plasma chamber or external to it. For example, a liquid secondary reactant can be deployed in a pool or as a layer on a surface exterior to the plasma chamber where it can be struck by the energized oxygen species. Or, for example, a liquid secondary reactant can be atomized into droplets and sprayed into the plasma chamber to interact with the energized oxygen species therein, or it can be sprayed external to the plasma chamber to be struck by the energized oxygen species as they exit the plasma chamber. The increased surface area of the sprayed liquid can bring more of the secondary reactants into contact with the energized oxygen species, enhancing product formation. Liquids such as petroleum-derived oils or agricultural bio-oils can be used as secondary reactants for this exemplary form of treatment. Selective oxidation using these secondary reactants can produce polar liquids that can be separated from the secondary reactant feedstock oils for product isolation.

In embodiments, atomization techniques can be used to bring the secondary reactant into contact with the energized species derived from the plasma. For example, a polar liquid can be atomized into minute droplets and sprayed so that it encounters the activated species from the plasma. The atomization of the liquid, especially a polar oil, including without limitation oils such as unsubstituted, hydroxy-substituted or carboxy-substituted oils, ketones, aldehydes, esters, ethers, and the like, results in an increased surface area for this secondary reactant that can facilitate interactions with the active species. This atomization technique can be advantageously employed when the primary reactant is oxygen or an oxygen/water vapor mix.

While this invention has been particularly shown and described with references to preferred embodiments thereof, it will be understood by those skilled in the art that various changes in form and details may be made therein without departing from the scope of the invention encompassed by the appended claims.

1. A system for producing a selective oxidation product, comprising:
an oxidant gas source providing an oxidizing agent;
a delivery system for the oxidizing agent in fluid communication with the oxidant gas source, wherein the delivery system delivers the oxidizing agent into a plasma reactor, and wherein the plasma reactor energizes the oxidizing agent as a plasma to produce activated oxidant species;
a secondary reactant source providing a secondary reactant in a secondary reactant stream that is separated from the oxidizing agent, wherein the secondary reactant stream is directed to contact the activated oxidant species in a reaction zone, and wherein the contact between the activated oxidant species and the secondary reactant in the reaction zone produces a reaction that yields the selective oxidation product.

2. The system of claim 1, wherein the oxidizing agent is selected from the group consisting of water vapor, hydrogen peroxide, carbon monoxide, lower chain hydrocarbon oxygenates, alcohols, aldehydes, and ketones.

3. The system of claim 1, wherein the oxidizing agent comprises a heteroatom.

4. The system of claim 3, wherein the heteroatom is a halogen atom.

5. The system of claim 1, wherein the plasma reactor forms a non-thermal plasma.

6. The system of claim 5, wherein the plasma reactor comprises a dielectric barrier discharge system or a microwave discharge system.

7. The system of claim 1, wherein the plasma reactor is formed as a cylinder having a proximal end and a distal end, and having an inlet at the proximal end in fluid communication with the delivery system and an outlet at the distal end in fluid communication with the reaction zone, and wherein the oxidizing agent enters the inlet, is converted to the activated oxidant species within the plasma reactor, and exits through the outlet as activated oxidant species to enter the reaction zone.

8. The system of claim 1, wherein the activated oxidant species passes through pores in the plasma reactor to enter the reaction zone to contact the secondary reactant therein.

9. The system of claim 1, wherein the secondary reactant is a hydrogen source compound.

10. (canceled)

11. The system of claim 1, wherein the secondary reactant is selected from the group consisting of alkanes, alkenes, alkynes, and aromatic compounds.

12. The system of claim 1, wherein the secondary reactant comprises a heteroatom.

13. The system of claim 1, wherein the selective oxidation product is selected from the group consisting of alcohols, aldehydes, ethers, esters, ketones, epoxides, and organic acids.

14. The system of claim 1, wherein the secondary reactant is a liquid.

15. The system of claim 14, wherein the liquid is dispensed as an aerosol to contact the activated oxidant species in the reaction zone.

16. The system of claim 1, wherein the secondary reactant is energized separately and delivered to the reaction area in an activated state.

17. The system of claim 1, wherein the secondary reactant stream is directed through a conduit to contact the activated oxidant species in the reaction zone.

18. The system of claim 17, wherein the conduit is an external cylinder that surrounds the plasma reactor or wherein the conduit is a planar surface.

19. (canceled)

20. The system of claim 1, wherein the selective oxidation product exits the reaction zone in an effluent fluid stream.

21. (canceled)

22. (canceled)

23. The system of claim 20, further comprising a separator in fluid communication with the effluent stream that separates the selective oxidation product from the effluent fluid stream.

24. (canceled)

25. A system for producing a selective reduction product, comprising:
a reductant gas source providing a reducing agent;
a delivery system for the reducing agent in fluid communication with the reductant gas source, wherein the delivery system delivers the reducing agent into a plasma reactor and wherein the plasma reactor energizes the reducing agent as a plasma to produce activated reductant species;
a secondary reactant source providing a secondary reactant in a secondary reactant stream that is separated from the reductant gas, wherein the secondary reactant stream is directed to contact the activated reductant species in a reaction zone, and
wherein the contact between the activated reductant species and the secondary reactant in the reaction zone produces a reaction that yields the selective reduction product.

26. (canceled)

27. A method of reacting an oxidant and a differentially activated secondary reactant to form a selective oxidation product, comprising:
providing an oxidant source that produces an oxidant stream comprising the oxidant, and providing a secondary reactant source that produces a secondary reactant stream comprising a differentially activated secondary reactant, wherein the oxidant stream and the secondary reactant stream are separated from each other;
providing at least one plasma reactor;
directing the oxidant stream to enter the at least one plasma reactor while remaining separated from the secondary reactant stream;
energizing the oxidant within the at least one plasma reactor to form activated oxidant species, wherein the oxidizing agent and the activated oxidant species remain separated from the secondary reactant stream;
entraining the activated oxidant species in an activated oxidant stream;
directing the activated oxidant stream comprising the activated oxidant species to exit the at least one plasma reactor to enter a reaction zone; and
directing the secondary reactant stream to enter the reaction zone to interact with the activated oxidant species in the reaction zone, wherein the activated oxidant species reacts with the differentially activated secondary reactant in the reaction zone, thereby forming the selective oxidation product.

28-36. (Cancelled)

37. A method for producing a selective oxidation reaction, comprising:
providing a primary reactant stream comprising an oxidant;
providing a secondary reactant stream comprising a secondary reactant intended to react with the oxidant in the primary reactant stream;
separating the primary and the secondary reactant streams and maintaining separation between them;
activating the oxidant in the primary reactant stream in a first plasma to form an activated oxidant;
shielding the secondary reactant from the first plasma to maintain the secondary reactant in a differentially activated state; and
recombining the activated oxidant with the secondary reactant in the differentially activated state, thereby producing the selective oxidation reaction.

38. (canceled)

39. (canceled)

40. A method for producing a selective reduction reaction, comprising:
providing a primary reactant stream comprising a reductant;
providing a secondary reactant stream comprising a secondary reactant intended to react with the reductant in the primary reactant stream;
separating the primary and the secondary reactant streams and maintaining separation between them;
activating the reductant in the primary reactant stream in a first plasma to form an activated reductant;
shielding the secondary reactant from the first plasma to maintain the secondary reactant in a differentially activated state; and
recombining the activated reductant with the secondary reactant in the differentially activated state, thereby producing the selective reduction reaction.

41. (canceled)
